(19) United States
(12) Patent Application Publication
(10) Pub. No.: US 2015/0081837 A1
(43) Pub. Date: Mar. 19, 2015

(54) PROVISIONING A PLURALITY OF COMPUTING DEVICES

(71) Applicant: Google Inc., Mountain View, CA (US)

(72) Inventors: Emily Pantaleoni Bernier, Cambridge, MA (US); Geoffrey Allen Borggaard, Lincoln, MA (US); Jason Monk, Cambridge, MA (US)

(21) Appl. No.: 14/072,686

(22) Filed: Nov. 5, 2013

Related U.S. Application Data
(60) Provisional application No. 61/877,790, filed on Sep. 13, 2013.

(51) Int. Cl. H04W 8/24

(52) U.S. Cl. CPC H04W 8/24
USPC 709/217

(57) ABSTRACT

Example techniques and systems may facilitate self-provisioning of respective computing devices. In one example, a technique may include transmitting, by a first computing device and to a second computing device via NFC, a network identifier that identifies a wireless device-to-device communication connection (e.g., Bluetooth connection) broadcast from the first computing device and a service identifier identifying a connection service of the Bluetooth connection and receiving, from the second computing device via the Bluetooth connection, a request to access a configuration service at a web address. Responsive to receiving the request, the technique may include transmitting the request to the web address via an Internet connection of the first computing device, receiving, by the first computing device and via the Internet connection, provisioning information from the configuration service, and transmitting, by the first computing device and via the Bluetooth connection, the provisioning information to the second computing device.

This application claims the benefit of U.S. Provisional Patent Application No. 61/877,790, to Monk et al., filed Sep. 13, 2013, and entitled “PROVISIONING A PLURALITY OF COMPUTING DEVICES,” which is incorporated herein by reference in its entirety.

### BACKGROUND

Computing devices may be configured to execute a variety of different applications (e.g., software programs). Before a computing device can execute any application, the computing device may install certain applications, accounts, or other configuration information. This process may be described as provisioning the computing device. The provisioning process may involve installing applications or otherwise preparing the computing device to a state in which it can be handed-off to an end user for one or more specific uses or functions. For example, an administrator may interact with the user interface of the computing device such that the computing device receives instructions to download and/or install the applications intended for the end user, set up one or more accounts, establish security restrictions, disable one or more features, register the computing device, or perform any other configuration tasks. Each computing device to be provisioned may receive similar user input from the administrator and install the selected applications or perform any configuration tasks as indicated by the user input.

### SUMMARY

In one example, a method includes receiving, by a first computing device, account information for a plurality of users and a plurality of device identifiers, receiving, by the first computing device and from a second computing device via wireless device-to-device communication, a unique device identifier that identifies the second computing device, determining that the unique device identifier matches one of the plurality of device identifiers received by the first computing device, and responsive to the determination, transmitting, by the first computing device and via the wireless device-to-device communication, provisioning information to the second computing device, wherein the provisioning information comprises instructions for the second computing device to automatically configure itself, via a network, with one or more applications of a user account associated with one or more of the plurality of users.

In another example, a computing device includes one or more processors configured to receive account information for a plurality of users and a plurality of device identifiers, receive, from a user computing device via wireless device-to-device communication, a unique device identifier that identifies the user computing device, determine that the unique device identifier matches one of the plurality of device identifiers received by the computing device, and responsive to the determination, transmit, via the wireless device-to-device communication, provisioning information to the user computing device, wherein the provisioning information comprises instructions for the user computing device to automatically configure itself, via a network, with one or more applications of a user account associated with one or more of the plurality of users.

In an additional example, a computer-readable storage medium comprises instructions that, when executed, configure one or more processors of a computing device to receive account information for a plurality of users and a plurality of device identifiers, receive, from a user computing device via wireless device-to-device communication, a unique device identifier that identifies the user computing device, determine that the unique device identifier matches one of the plurality of device identifiers received by the computing device, and responsive to the determination, transmit, via the wireless device-to-device communication, provisioning information to the user computing device, wherein the provisioning information comprises instructions for the user computing device to automatically configure itself, via a network, with one or more applications of a user account associated with one or more of the plurality of users.

In an additional example, a method includes receiving, by a first computing device and from a second computing device via wireless device-to-device communication, a unique device identifier that identifies the second computing device, determining that the unique device identifier matches one of a plurality of device identifiers received by the first computing device, and responsive to the determination, transmitting, by the first computing device and via wireless device-to-device communication, provisioning information to the second computing device, wherein the provisioning information comprises network credentials that allow the second computing device to access a network, one or more setting values that limit a respective function of the second computing device, an administrator password, and instructions for the second computing device to automatically configure, via the network, itself with at least one application for use by a user.

In an additional example, a method includes determining, by a first computing device, that no user account has been established on the first computing device, responsive to the determination, initiating, by the first computing device, a short-range communication unit that is configured to communicate via wireless device-to-device communication, responsive to detecting a second computing device that broadcasts a provisioning service via the wireless device-to-device communication, transmitting, by the first computing device and to the second computing device, a unique device identifier that identifies the first computing device, receiving, by the first computing device and from the second computing device, provisioning information comprising instructions for the first computing device to automatically configure itself, via a network, with one or more applications of a user account, and responsive to receiving the provisioning information, automatically configuring, by the first computing device and via a network, the first computing device with the one or more applications of the user account.

In an additional example, a method includes transmitting, by a first computing device and to a second computing device via near-field communication, a network identifier and a service identifier, wherein the network identifier identifies a wireless device-to-device communication connection broadcast from the first computing device, and wherein the service identifier identifies a connection service of the wireless device-to-device communication connection, receiving, by the first computing device and from the second computing device via the wireless device-to-device communication connection and the connection service, a request to access a configuration service at a web address, responsive to receiving the request, transmitting, by the first computing device, the request to the web address of the configuration service via an Internet connection of the first computing device, receiving, by the first computing device and via the Internet connection, provisioning information from the configuration service and for the second computing device, and transmitting, by the first computing device and via the wireless device-to-device communication connection and the connection service, the provisioning information to the second computing device, wherein the provisioning information comprises instructions for the second computing device to automatically configure itself with a wireless network detectable by the second computing device and a password that allows the second computing device to access the wireless network for a unique user account associated with the second computing device.

In an additional example, an administrator computing device including a near-field communication unit configured to exchange data via near-field communication, a wireless device-to-device communication unit configured to exchange data via a wireless device-to-device communication connection, a network interface configured to establish an Internet connection, and one or more processors configured to control the near-field communication unit to transmit, to a first computing device via near-field communication, a network identifier and a service identifier, wherein the network identifier identifies the wireless device-to-device communication connection broadcast from the wireless device-to-device communication unit, and wherein the service identifier identifies a connection service of the wireless device-to-device communication connection, control the wireless device-to-device communication unit to receive, from the first computing device via the wireless device-to-device communication connection and the connection service, a request to access a configuration service at a web address, responsive to receiving the request, control the network interface to transmit the request to the web address of the configuration service via the Internet connection, receive, via the Internet connection, provisioning information from the configuration service and for the first computing device, and control the wireless device-to-device communication unit to transmit, via the wireless device-to-device communication connection and the connection service, the provisioning information to the first computing device, wherein the provisioning information comprises instructions for the first computing device to automatically configure itself with a wireless network detectable by the first computing device and a password that allows the first computing device to access the wireless network for a unique user account associated with the first computing device.

In an additional example, a computer-readable storage medium including instructions that, when executed, configure one or more processors of a first computing device to transmit, to a second computing device via near-field communication, a network identifier and a service identifier, wherein the network identifier identifies a wireless device-to-device communication connection broadcast from the first computing device, and wherein the service identifier identifies a connection service of the wireless device-to-device communication connection, receive, from the second computing device via the wireless device-to-device communication connection and the connection service, a request to access a configuration service at a web address, responsive to receiving the request, transmit the request to the web address of the configuration service via an Internet connection of the first computing device, receive, via the Internet connection, provisioning information from the configuration service and for the second computing device, and transmit, via the wireless device-to-device communication connection and the connection service, the provisioning information to the second computing device, wherein the provisioning information comprises instructions for the second computing device to automatically configure itself with a wireless network detectable by the second computing device and a password that allows the second computing device to access the wireless network for a unique user account associated with the second computing device.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device that is configured to transmit, via wireless device-to-device communication, provisioning information to respective user devices, in accordance with one or more aspects of the present disclosure.

FIGS. 2A and 2B are block diagrams of example computing devices described herein.

FIGS. 3A and 3B are block diagrams of example user devices described herein.

FIG. 4 is a flow diagram illustrating an example process for transmitting provisioning information to one or more user devices.

FIG. 5 is a flow diagram illustrating an example process for receiving provisioning information at a user device from a computing device.

FIG. 6 is a flow diagram illustrating an example process for a user device to perform a self-provisioning process using received provisioning information.

FIG. 7 is a conceptual diagram illustrating an example computing device that is configured to facilitate the distribution of provisioning information from a configuration service to respective user devices, in accordance with one or more aspects of the present disclosure.

FIG. 8 is a flow diagram illustrating an example process for connecting a user device with a configuration service via a computing device to distribute provisioning information to the user device.

FIG. 9 is a flow diagram illustrating an example process for transmitting a request to and receiving provisioning information from a configuration service via a wireless device-to-device communication connection with a computing device.

### DETAILED DESCRIPTION

The disclosure describes examples of transmitting provisioning information to respective computing devices for self-provisioning of each of the respective computing devices. Before a computing device is ready for use by an end-user (e.g., a user of the computing device), the computing device may be provisioned, or set-up, with various software applications, values for various settings or configuration parameters, and any other user-specific information that facilitates use of the computing device. Typically, a person may manually interact with a user interface of the computing device to provide input to the computing device such that the computing device installs applications, sets values for various settings, or performs any other functions in response to the user input during the provisioning process.

This process of provisioning the computing device may be potentially problematic for large entities (e.g., schools, businesses, or other organizations) for which dozens, hundreds, or even thousands of computing devices are to be provisioned for use by respective users (e.g., students or employees). Although each of the users can receive their respective non-provisioned computing devices and perform the manual provisioning process themselves, this option may result in the computing device being improperly provisioned, extensive set-up time for each user of a respective user computing device, and administrator level control by the user may instead of the entity. Moreover, the user-based provisioning process may be impractical for technologically novice users and small children. In some cases, an information technology (IT) professional of the entity may provision each of the computing devices, but this manual provisioning process may be inefficient and too time consuming for a practical solution.

As described herein in some examples, the provisioning process for user computing devices (e.g., mobile computing devices such as smartphones or tablet computers, notebook computers, or desktop computers) may be at least partially automated such that an administrator computing device transmits provisioning information (e.g., unique provisioning information or generic provisioning information) to the respective user computing device via device-to-device communication. For example, an administrator computing device may be operational and establish a provisioning service that facilitates wireless device-to-device communication. This wireless device-to-device communication may be short-range communication, such as a communication utilizing the Bluetooth protocol or other wireless communication protocol over a limited distance. The limited distance (e.g., less than 100 meters, less than 10 meters, or even less than 1 meter) may allow for the administrator device to communicate with intended user devices (e.g., user devices within the same room as the administrator device) while excluded unintended computing devices that are not to be provisioned. The direct wireless device-to-device communication may facilitate initial communications in which additional network credentials and/or passwords are not necessarily required.

Using the wireless device-to-device communication, the administrator device can transmit provisioning information to one or more user devices that may require user account information to be utilized by an end-user. In response to receiving the provisioning information, each of the user computing devices may automatically connect to a network, retrieve information (e.g., software applications or values for various settings) associated with a user account indicated by the provisioning information, and otherwise set up the user computing device for use by one or more users associated with the user account. In this manner, each of the user computing devices may be provisioned for respective user accounts by automatically communicating with an administrator device within short-range communication range, without a user necessarily needing to physically touch or manually interact with the user interface of each user computing device. In other examples, the provisioning information may be generic to each user device such that a user account is added to each user device by the user or other later time.

In some examples, the administrator computing device may generate unique provisioning information for the user accounts of each of the plurality of users. The unique provisioning information may indicate or include a user account associated with each of the users. The user account may be a unique portion of the provisioning information for each user computing device. In addition, the unique provisioning information for many users may include some common information. For example, the provisioning information may identify or include network credentials that allow the user computing device to recognize and/or access a network to complete the provisioning process.

In one example, the administrator computing device may transmit the unique provisioning information via a short-range communication, such as one utilizing a Bluetooth protocol (e.g., an example of wireless device-to-device communication). The administrator computing device may broadcast a provisioning service via the short-range communication. Upon powering up of a user computing device that has not been set-up with a user account, the user computing device may automatically initiate a short-range communication unit and discover the provisioning service broadcast by the administrator computing device. The user computing device may then transmit a unique device identifier to the administrator computing device. Responsive to the unique device identifier matching a list of device identifiers associated with the administrator computing device, the administrator computing device may retrieve the unique provisioning information for the user computing device and transmit the unique provisioning to the user computing device via the short-range communication. In some examples, the administrator will also transmit the unique device identifier for the user computing device to complete the authentication process. The unique provisioning information may include a packet of data that is transmitted quickly, such as less than a minute or only a few seconds. In response to receiving the unique provisioning information, the user computing device may use the unique provisioning information to connect to a wireless network and retrieve applications, setting values, or any other information related to one or more accounts identified by the unique provisioning information. The administrator computing device may transmit, via the short-range communication, respective unique provisioning information to other user computing devices (e.g., simultaneously and/or sequentially).

In other examples, the administrator computing device may establish a wireless device-to-device communication connection (e.g., communication according to a Bluetooth protocol) with one or more user devices and facilitate the transfer of provisioning information from a configuration service (e.g., an Internet-based service), through the administrator device, and to the respective user computing device. In other words, each of a plurality of user devices may obtain provisioning information from the configuration service without using an Internet connection (e.g., Wi-Fi Internet connection). Instead, the user devices may utilize the Internet connection of the administrator device to obtain provisioning information (e.g., network credentials, a unique user account, and/or applications to install by the user device) from the configuration service. In this manner, the administrator device may not store sensitive user account information, such as network credentials (e.g., network access passwords) or user account passwords. Instead, the administrator device may act as a pass-through for communications between the new user device and the configuration service.

In one example, the administrator device may transmit, to a user device via near-field communication (NFC), a network identifier that identifies a wireless device-to-device communication connection (e.g., a Bluetooth connection) broadcast from the administrator device and a service identifier (e.g., a universally unique identifier (UUID)) that identifies a connection service of the wireless device-to-device communication connection. In other words, the connection service may a Bluetooth service that acts as a temporary Internet connection to a Bluetooth connected device such as the user. The user device may then enable a wireless device-to-device communication unit of the user device and transmit, to the administrator device via a wireless device-to-device communication connection and the connection service, a request to access a configuration service at a web address. The administrator device may then receive the request transmitted via the wireless device-to-device communication connection and, responsive to receiving the request, transmit the request to the web address of the configuration service via an Internet connection (e.g., a Wi-Fi connection). The administrator device may receive, via the Internet connection, provisioning information for the user device and transmit, via the wireless device-to-device communication connection, the provisioning information to the user device.

The provisioning information may include instructions for the user device to automatically configure itself with one or more applications of a unique user account, with one or more network credentials (e.g., a network identity and/or a network password for accessing the network identified by the network identity), set up one or more accounts, establish one or more security/privacy restrictions, disable one or more features, register the user device, or perform any other configuration tasks specific to the unique user account. In some examples, the user device may not receive any specific information related to a unique user account from the administrator device or the user device. In this manner, the network identifier, service identifier, and the web address for the configuration service may be generic to any user device. In other examples, the administrator device may transmit, with the initial network identifier and service identifier, an indication of the unique user account (e.g., a user name for the unique user account that gives an identity to the user device) before communicating with the configuration service and/or a device identifier (e.g., serial number of the user device) that allows the user device to authenticate the administrator device. The web address of the configuration service may be hardcoded (e.g., stored in a memory) in the user devices and/or transmitted to the user devices from the administrator device (e.g., via NFC) or another source (e.g., an NFC tag or optical code).

One or more aspects of the disclosure may be operable only when a user has explicitly enabled such functionality. For example, in one or more aspects, an administrator computing device may only obtain account information and/or transmit provisioning information in the instance where an administrator and/or the respective users have explicitly consented to the use of such data. In addition, in one or more aspects, account information may only be transmitted between computing device only when the users/owner of such account has consented to such transmission or use of the data. In these aspects, each user may control any and all of data collection and data transmission as described herein. The user may consent or revoke consent to the collection and/or transmission of any data at any time. Furthermore, various aspects of the disclosure may be disabled by the user.

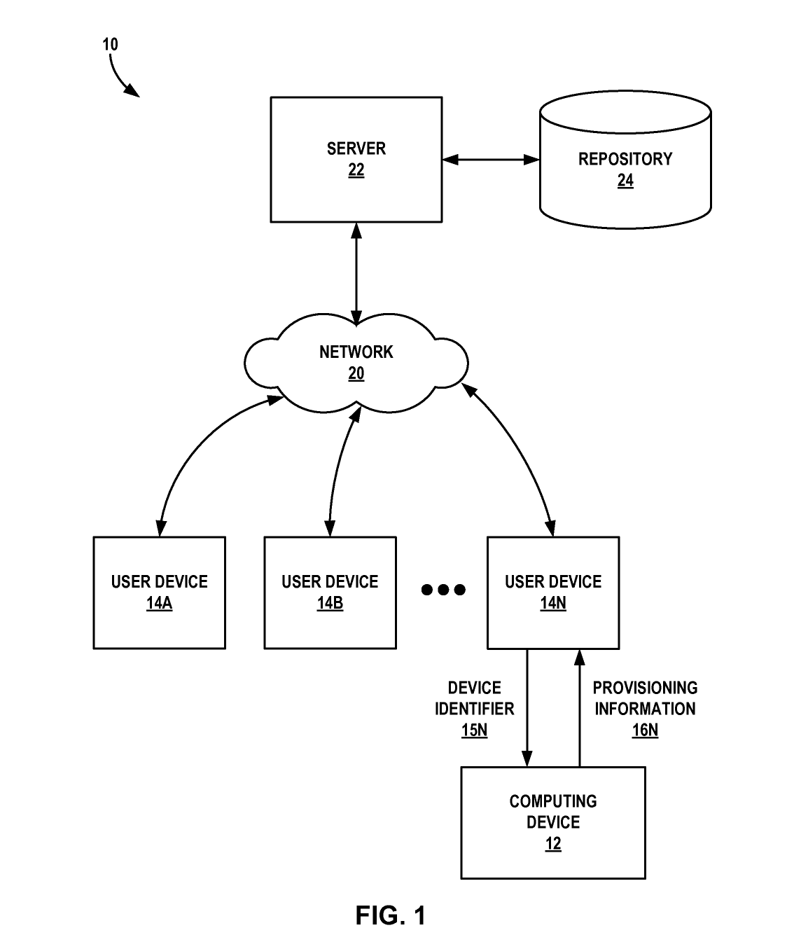

FIG. 1 is a conceptual diagram illustrating an example computing device 12 that is configured to transmit, via wireless device-to-device communication, unique provisioning information to respective user devices 14. As shown in FIG. 1, system 10 includes computing device 12, user devices 14A, 14B, and 14N (collectively “user devices 14”), network 20, networked server 22, and repository 24. Computing device 12, in some examples, is or is a part of a portable computing device (e.g., a mobile phone, a smartphone, a netbook computer, a notebook computer, a tablet computing device, or a smart watch). In other examples, computing device 12 may be at least a part of a workstation or other non-portable computing device. Computing device 12 may be described as an administrator computing device, as computing device 12 may used by an administrator or other person in control of provisioning user devices 14. Each of user devices 14 may be user computing devices intended for use by end-users such as students or employees associated with an entity.

Computing device 12 may be configured to connect to network 20 (e.g., a wired or wireless network). In some examples, computing device 12 may also be configured to communicate with networked server 22 via network 20 to manage one or more accounts and/or access information stored in repository 24. Subsequent to receiving respective provisioning information 16, as described in more detail below, user devices 14 may also be configured to connect to network 20 and communicate with server 22. Although network 20 may be a single network, network 20 may be representative of two or more networks configured to provide network access to server 22 and/or repository 24.

Computing device 12 may include various components that provide respective functionality. For example, computing device 12 may include a display device and one or more cameras, microphones, and speakers. The display device may include one or more input devices and/or output devices that facilitate administrator communication with computing device 12. In one example, the display device may include a touch screen interface (e.g., a presence-sensitive display that includes a presence-sensitive input device). In other examples, the display device may include a display and one or more buttons, pads, joysticks, mice, tactile device, or any other device capable of turning user actions into electrical signals that control computing device 12. In any example, the administrator may interact with the display device or any other input devices to provide input prior to or during the processes described herein. Each of user devices 14 may include similar features, such as one or more display devices, cameras, microphones, and speakers.

In the example of FIG. 1, computing device 12 and user devices 14 are described as a tablet computing device (e.g., a mobile computing device). However, in other examples, computing device 12 and user devices 14 may be a personal digital assistant (PDA), a desktop computer, a laptop computer, a tablet computer, a portable gaming device, a portable media player, a camera, an e-book reader, a watch, or another type of computing device. Although computing device 12 and user devices 14 may all be the same type of device (e.g., tablet computing devices), different types of devices may still provide device-to-device communication used during the provisioning process. For example, computing device 12 may be a notebook computer and user devices 14 may be tablet computing devices. In addition, user devices 14 may or may not all be of the same type of computing device.

As described herein, each of user devices 14 may communicate with one or more servers 22 to retrieve information related to accounts associated with the provisioning information transmitted by computing device 12. Each of user devices 14 may initially be new or previously unused devices, or one or more of user devices 14 may have been restored to factory settings or otherwise not be associated with any user-specific information (such as a user account). Prior to receiving provisioning information from computing device 12, each user device 14 may include some software or applications, such as an operating system and/or other software that allows for minimum level of functionality of the respective user device. However, until user devices 14 are provisioned, each user device may not have any specific or unique information or data related to any specific user. In this manner, user devices 14 may be generic devices with generic software pre-installed. Computing device 12 may begin the provisioning process which includes changing various setting values, adding additional software, and/or removing selected software to personalize the respective user device to a selected user account associated with one or more of a plurality of users.

In one example, computing device 12 (e.g., an administrator device configured to begin the provisioning process) may be configured to receive account information for a plurality of users and receive a plurality of device identifiers. The account information may or may not include respective device identifiers. In other words, the account information may or may not associate each of the plurality of users with a respective device identifier of one of user devices 14. Computing device 12 may also be configured to receive, via wireless device-to-device communication, a unique device identifier 15N that identifies the user computing device (e.g., user device 14N) and determine that unique device identifier 15N matches one of the plurality of device identifiers previously received by computing device 12. Computing device 12 may also be configured to, responsive to the determination that device identifier 15N matches one of the plurality of device identifiers, transmit, via the wireless device-to-device communication, provisioning information 16N to user device 14N. Provisioning information 16N may include instructions for user device 14N to automatically configure itself, via network 20, with one or more applications of a user account associated with one or more of the plurality of users.

As shown in FIG. 1, user device 14 may be configured to transmit device identifier 15N in response to detecting the wireless device-to-device communication available from computing device 12. As described herein, computing device 12 may be an administrator device that has initiated a short-range communication unit to communicate with other devices. In some examples, computing device 12 may broadcast a provisioning service via this short-range communication. The short-range communication may be performed via any number of short-range communication protocols, such as the Bluetooth protocol. When computing device 12 is broadcasting the provisioning service, user devices (e.g., user devices 14A, 14B, and 14N) may be able to communicate with computing device 12.

When each user device 14 is powered on, the user device may search for a user account set-up with the user device. If any of user devices 14 are powered on and cannot identify any established user account on the device, the user device may execute instructions that cause the user device to look for computing device 12 and/or allow the user device to receive requests from computing device 12 to initiate the provisioning process. For example, user device 14N may determine that no user account is set-up and search or scan for a computing device, such as computing device 12, which is broadcasting a provisioning service via short-range communication. Responsive to detecting the provisioning service broadcast by computing device 12, user device 14N may transmit device identifier 15N to computing device 12.

In other examples, computing device 12 may be configured to, via short-range communication, sense a user device 14 that is in wireless communication range of computing device 12. Responsive to sensing, or detecting, the user device, computing device 12 may be configured to transmit a request for unique device identifier 15N (or a representation of the device identifier) from the user device 14N. In this manner, either user devices 14 and/or computing device 12 may be actively searching for administrative device or new user devices, respectively.

In some examples, the device identifier 15N may be a serial number that is unique to the hardware of user device 14N. The serial number may be assigned by the manufacturer of the user device and stored in a memory of user device 14N. In other examples, the unique device identifier may be a unique number assigned to a specific hardware component, product key of a software application or operating system stored on user device 14N, or any other number, word, or code that identifies the specific user device 14N. Each of user devices 14 would have a respective unique device identifier.

In some examples, user device 14N may not transmit the actual device identifier of the user device. Instead, user device 14N may transmit a representation of device identifier 15N. This representation may be indicative of the device identifier to computing device 12 but non-identifying of user device 14N to other devices or systems. For example, user device 14N may encrypt the device identifier to generate device identifier 15N. Computing device 12 may be configured to decrypt the encrypted device identifier or otherwise match the encrypted device identifier to a list of device identifiers associated with user devices to be provisioned. In one example, user device 14N may be configured to generate a hash of the actual device identifier to generate device identifier 15N to be transmitted. Use of a hash function, for instance, may prevent the actual device identifier of the respective user devices 14 to be transmitted. These examples may be utilized to increase the security of information transmitted between user devices 14 and computing device 12.

Responsive to receiving device identifier 15N, computing device 12 may compare device identifier 15N to a list of one or more device identifiers associated with user devices to be provisioned. This list of device identifiers may be received from a master account when the respective user devices 14 are purchased or otherwise retrieved or stored in memory of computing device 12. In some examples, computing device 12 may receive the list of device identifiers from server 22 via network 20. Upon determining that device identifier 15N matches of the device identifiers on the list, computing device 12 may retrieve and/or generate the appropriate provisioning information 16N and transmit provisioning information 16N to user device 14N.

In some examples, computing device 12 may complete an authentication process, or handshaking process, with user device 14. For example, computing device 12 may generate or retrieve a different hash or different encrypted form of device identifier 15N and transmit the different form of device identifier 15N back to user device 14N. User device 14N may analyze the received device identifier and determine that the different form of the identifier is representative of the actual device identifier of user device 14N. In this manner, user device 14N can confirm that computing device 12 is authorized to transmit provisioning information 16N. In one example, computing device 12 may transmit the different form of the device identifier with provisioning information 16N. In other examples, computing device 12 may transmit the different form of the device identifier first and only transmit provisioning information 16N in response to receiving a confirmation from user device 14N confirming that computing device 12 was authenticated.

In response to receiving provisioning information 16N, user device 14N may configure itself by using at least a portion of provisioning information 16N to access network 20 and retrieve additional information related to one or more accounts indicated by provisioning information 16N. As shown in FIG. 1, computing device 12 has already transmitted provisioning information (e.g., provisioning information similar to provisioning information 16N) to each of user devices 14A and 14B. Respective device identifiers and provisioning information are not shown in FIG. 1, but each of user devices 14A and 14B have already transmitted a respective device identifier to computing device 12 and received respective provisioning information from computing device 12. User devices 14A and 14B can thus automatically retrieve additional information from server 22 via network 20 and configure themselves with information related to respective user accounts. In this manner, computing device 12 may transmit different provisioning information to respective user devices (e.g., dozens or hundreds of user devices similar to user devices 14) and let each of the user devices complete the configuration, or provisioning process, without any further input from computing device 12 or user interaction. Computing device 12 may transmit the respective unique provisioning information to each user device 14 iteratively or simultaneously. For example, computing device 12 may iteratively communicate user devices 14 by receiving the respective device identifier 15N and transmitting the respective provisioning information prior to communicating with another one of user devices 14. In another example, computing device 14 may communicate simultaneously with two or more user devices 14 using the short-range communication (e.g., a Bluetooth protocol). Therefore, computing device 14 may be configured to transmit respective provisioning information to respective user devices 14 simultaneously. Computing device 14 may also receive device identifiers and/or transmit provisioning information simultaneously, as needed.

Computing device 12 may receive account information for, or associated with, a plurality of users. The plurality of users may be end-users that will interact with respective user devices 14. For example, the plurality of users may be students enrolled in one or more classes, employees of a company, or any other group of users. Typically, the plurality of users may be associated with a single entity or institution. However, the plurality of users may be associated with different entities in other examples. The account information may include information associated with one or more types of accounts. For example, the account information may include information identifying and/or describing user accounts for each of the plurality of users. In some examples, each of the user accounts may be associated with groups of the users. Since each user account may differ by at least the user to which it is associated, the information related to the user accounts may make provisioning information for one of user devices 14 different than, or unique from, provisioning information for another one of user devices 14. In some examples, the user accounts may be stored in the form of a list of all users within a particular group of users that will receive user devices 14. Although the account information may include device identifiers for respective user devices 14 to be provisioned, the list of device identifiers may be stored separately and assigned to respective user accounts by computing device 12 and/or as part of the self-provisioning process completed by the respective user device 14.

The account information may also include information identifying and/or describing an owner account associated with an entity or institution that owns or otherwise manages user devices 14. The owner account may be common to all of user devices 14. In this manner, each of user devices 14 may be managed by the administrator that has access to the owner account. Management of each user device 14 may be performed remotely by an administrator via network 20 such that various tasks may be performed without user interaction. By including both owner account information and user account information, each of user devices 14 may be provisioned with the owner account and a unique user account.

In some examples, the owner account may be used during self-provisioning of user devices 14 (e.g., to set various setting values, validate user accounts, or provide temporary administrator access). After user device 14 is configured, or provisioned, user device 14 may delete the owner account from user device 14. In another example, the owner account may be a single-use account that is used during the provisioning process. This single-use account may be used by user device 14 to configure itself via network 20 and server 22. However, after user device 14 is configured with one or more user accounts, the single-use account may be inactive and/or deleted by user device 14.

In this manner, each unique provisioning information (e.g., provisioning information 16N), may include information indicative of one or more types data. The unique provisioning information may include information indicative of an owner account associated with an entity to be in control of user devices 14 and a respective user account associated with one of the plurality of users. The unique provisioning information may also include information related to a network and/or server that allows the respective user device 14 to connect to network 20 and retrieve applications, setting values, and any other information related to the owner account, the user account, or otherwise provision user device 14 for the user. In some examples, the information related to the network may include network credentials for accessing network 20. The network credentials may include the name of the network (e.g., a wireless network) and a password that enables the user device to access network 20. The password may be generic to all user accounts or user account specific (e.g., each set of unique provisioning information may include a different password to network 20). After receiving unique provisioning information that includes this data, the receiving user device may initiate the self-provisioning process (e.g., retrieving applications or any other data from server 22 to configure the user device for use by the user of the user account).

In some examples, the provisioning information may include or indicate a device policy that provides one or more limitations to respective functions of the user device. In other words, the device policy may be indicated by one or more setting values to respective features or functions that limit, block, or otherwise regulate each of user devices 14 to the requirements of the device policy. For example, the device policy may block certain component functions (e.g., cameras), functionalities, and/or access to various networks and/or websites, or restrict any other features or content. As another example, the setting values of the device policy may prevent a user from installing games or any other unauthorized applications. In other words, the device policy may set one or more rules for use or otherwise lockdown one or more functions of each one of user devices 14 before a user has access to the respective user device.

The device policy may be generic to all user accounts or customized to one or more user accounts. Each user device 14 may retrieve setting values for the device policy from server 22 during the self-provisioning process after receiving the unique provisioning information. Alternatively, the provisioning information transmitted by computing device 12 may include the one or more setting values for respective functions of the device policy. In other examples, the device policy may be included in or associated with the owner account and/or specific user account.

Before computing device 12 (e.g., an administrator computing device) transmits provisioning information 16N to user device 14N, computing device 12 may be configured to sense that user device 14N is within wireless communication range of computing device 12. For example, each of user devices 14 and computing device 12 may need to detect each other's communication signals. As described herein, one type of wireless communication that may, in certain non-limiting examples, be used to transmit and receive device identifiers and provisioning information is a communication using the Bluetooth protocol. The Bluetooth communication protocol is a wireless short-range communication protocol using short-wavelength radio transmissions in a particular frequency band. Bluetooth communications (i.e., wireless communication using the Bluetooth protocol) may use signals in the range of 2400-2483.5 MHz. Bluetooth communications may also be based on a packet-based protocol and operate in a master-slave configuration. The range of Bluetooth communications may be generally between approximately 1 meter and approximately 100 meters. In some examples, user devices 14 and computing device 12 may be configured with short-range communication units configured to transmit and/or receive Bluetooth communications in a range less than 30 meters, or even less than 10 meters. In other examples, the range of Bluetooth communications may be less than 5 meters or even less than 1 meter in range. The range of Bluetooth communications may be at least partially limited by the power of the communication unit (i.e., Bluetooth transceiver). As some examples, power up to 100 milliWatts (mW) may allow for a range of up to 100 meters, power up to 2.5 mW may allow for a range of up to 10 meters, and power up to 1 mW may allow for a range of up to 1 meter. User devices 14 and computing device 12 may be configured with a power to achieve the desired wireless communication range. In other examples, a short-range communication protocol using radio-frequency identification (RFID) or near-field communication (NFC) may be implemented into system 10.

Provisioning information 16N may be unique provisioning information that is different from the provisioning information transmitted to any other user devices 14. Provisioning information 16N may thus include unique provisioning information specific for each of the plurality of users associated with respective user accounts. In this manner, computing device 12 may only transmit provisioning information 16N to user device 14N. Computing device 12 may be configured to transmit provisioning information 16N to any user device that has not already received provisioning information or already been provisioned. In other examples, computing device 12 may transmit provisioning information 16N responsive to sensing that user device 14N is a type of computing device compatible with provisioning information 16N. For example, computing device 12 may determine that user device 14N is a certain model or type of computing device that includes an operating system and/or components compatible with the applications to be retrieved based on provisioning information 16N.

Prior to transmitting provisioning information 16N, computing device 12 may be configured to generate the unique provisioning information for each of the plurality of users, or user accounts associated with each of the plurality of users. For example, computing device 12 may be configured to generate, based on user specific and common information, respective packets of unique provisioning information for subsequent transmission to respective user devices 14. In one example, computing device 12 may generate all of the unique provisioning information for all of the users prior to transmitting provisioning information to any user devices 14. In this manner, computing device 12 may select pre-generated unique provisioning information in response to sensing one of user devices 14. In another example, computing device 12 may generate respective unique provisioning information in response to sensing a new user device 14 or receiving a device identifier. In this manner, computing device 12 may generate provisioning information, such as unique provisioning information 16N, on demand. The on demand technique for generating unique provisioning information may also allow computing device 12 to tailor the unique provisioning information to the type or model of computing device that is the sensed user device 14. Alternatively, computing device 12 may receive all of the unique provisioning information from server 22 or another device or service.

The provisioning process illustrated in the example of FIG. 1 may not be isolated to a single user device. Instead, the provisioning process may be used by computing device 12 to complete rapid provisioning of some or all of user devices 14. Computing device 12 may simultaneously communicate with several user devices 14 at any given time. The number of user device 14 to be simultaneously communicating with computing device via the wireless device-to-device communication may be limited by a number of communication slots (channels) and/or available data bandwidth. In other examples, computing device 12 may only communicate with one user device 14 at a given time and move to the next user device upon completion of transmitting the provisioning information for that particular user device 14. User devices 14 may be configured to set up in a queue to establish communication with computing device 12. For example, each user device 14N may continue to ping computing device 12 until computing device 12 has the bandwidth to response.

For example, subsequent to computing device 12 transmitting the provisioning information 16N to user device 14N, computing device 12 may sense an additional one of user devices 14 (not shown) in wireless communication range of computing device 12. In response to sensing the additional one of user devices 14, computing device 14 may select an additional set of unique provisioning information associated with another user account of the plurality of user accounts. The additional set of unique provisioning information may include instructions for the additional one of user devices 14 to automatically configure itself, via network 20, with one or more applications of the additional user account associated with the user. In response to the selection, computing device 12 may transmit the additional set of unique provisioning information to the additional one of user devices 14 once the additional user device is within wireless communication range.

Computing device 12 may continue the transmission of respective provisioning information until computing device 12 has transmitted the respective provisioning information to each of user devices 14 or provisioning information associated with each of the user accounts has been transmitted to a respective user device 14. In some examples, computing device 12 may select the additional set of unique provisioning information by moving to the next user, or user account, in a list of user accounts to be provisioned on respective user devices 14. Computing device 12 may store an indication to each user account for which provisioning information has been transmitted. If a user device 14 was not provisioning correctly, or an administrator wishes to provision only one of user devices 14 separately, computing device 12 may be configured to select a specific user account, or subset of user accounts, based on user input. Computing device 12 may then transmit unique provisioning information for the selected user account without requiring the provisioning of other user devices 14. In this manner, computing device 12 may transmit provisioning information automatically (e.g., without administrator input) to all user devices 14 or on a semi-automatic basis in which administrator input is provided to computing device 12 to control which unique provisioning information is transmitted to respective user devices 14.

In some examples, computing device 12 may be configured to receive a confirmation signal from a user device 14 via the wireless device-to-device communication, subsequent to transmitting the respective set of unique provisioning information, confirming that the set of provisioning information was received by the user device. In response to receiving the confirmation signal, computing device 12 may be configured to indicate that the user account associated with that provisioning information has been used to provisioning a user device 14. In other examples, computing device 12 may be configured to receive continuing status reports over the course of the processes, such as when a packet of data is received, or when each part of the process is completed successfully. An error may be transmitted upon any unsuccessful step of the process. Computing device 12 may then begin to sense for an additional user device for transmission of the next set of unique provisioning information. Computing device 12 may receive the confirmation signal via the device-to-device communication through which the provisioning information was transmitted or another communication modality.

In addition, or alternatively, computing device 12 may output a user detectable indication confirming the provisioning information was received by the respective user device. In some cases, the confirmation may be a series of indications corresponding to respective steps in the process of obtaining provisioning information. The user detectable indication may be an audible signal or visual signal configured to cue the administrator to set aside the user device 14 that sent the confirmation signal and place another user device 14 in communication range of computing device 12. In some examples, the user device 14 may output a user detectable indication that the unique provisioning information was received. The user device output of the user detectable indication may be in addition to the output from computing device 12 or instead of the user detectable indication from computing device 12.

In other examples, the confirmation signal transmitted from the user device 14 and received by computing device 12 may be an error signal indicating that there were one or more errors in the provisioning information sent by computing device 12. The error signal may be generated by user device 14 during a loss in communication during transmission of the unique provisioning information, for example. In response to receiving the error signal, computing device 12 may present an indication to the administrator that another attempt at transmission is required and/or automatically transmit the same unique provisioning information again. Alternatively, responsive to receiving the error signal, computing device 12 may mark the user account associated with the transmitted unique provisioning information as unsuccessful for a second attempt at transmission once provisioning information is transmitted to the rest of user devices 14 during the provisioning session.

Although the provisioning information transmitted by computing device 12 may be unique for each of user devices 14 in some examples, the provisioning information may be generic for all user devices 14 in other examples. When computing device 12 is configured to transmit generic provisioning information, each user device 14 may receive user input identifying a specific user account to be added to the user device after the user device has self-configured itself.

Provisioning information may include the actual data for each feature (e.g., the setting values) or an indication of the actual data such that user device 14 can reconstruct the actual data from the indication and/or retrieve the actual data via network 20. For example, the provisioning information may include an indication of an owner account and/or a device policy, and user device 14N may retrieve the administrator password and/or setting values related to the identified owner account or device policy from server 22. When user device 14N configures itself with at least one application for user by a user, user device 14N may initiate one or more software applications, set-up one or more functions for use, and/or download the applications or software related to the applications from server 22.

In some examples, in response to connecting with network 20 and server 22 for the first time after receiving the provisioning information, user device 12 may transmit a unique device identification number to server 22. Server 22 may then register user device 12 to the server. This server registration may allow server 22 to prompt a user to add a user account to user device 14N and/or be required by server 22 for a user account to be manually added to user device 14N.

After user device 14N is configured with the generic provisioning information, a user (e.g., a student or employee) may interact with user device 14N to enter information related to the user account of the user. In response to receiving this information from the user, user device 14N may further configure itself with information related to the user account. User account information may be separately, or manually, entered by the user in situations in which the user account is already set-up to prevent computing device 12 from either acquiring the user's password and/or requiring the user to select a new password after the old user password was used to provision user device 14N via computing device 12.

The wireless device-to-device communication used by computing device 12 to transmit the unique provisioning information (e.g., provisioning information 16N) may be any communication protocol or modality that facilitates the transfer of data directly between computing device 12 and user devices 14. In one example, the wireless device-to-device communication includes Bluetooth communication, such that a short-range communication unit may be configured to operate according to the Bluetooth protocol. Other short-range communications may include near-field communication (NFC). In this manner, computing device 12 may include an NFC unit or module configured to transmit the provisioning information to NFC units of the respective user devices 14.

In some examples, computing device 12 may transmit the provisioning information using multiple communication modalities. For example, computing device 12 may initially establish communication with a user device 14 using NFC and then transmit the provisioning information over another communication modality, such as a Bluetooth connection. In other examples, computing device 12 may establish communication with a user device 14 using Bluetooth and then transmit the provisioning information over another communication modality, such as Wi-Fi or another indirect communication modality (e.g., a communication which a third device is required to relay communications).

Although wireless communication is generally described herein for transmitting provisioning information, wired communication may be utilized in alternative examples. For example, computing device 12 may transmit unique provisioning information via universal serial bus (USB), wired Ethernet connection, or any other non-wireless communication channel.

User devices 14 may generally connect to network 20 via an access point or other device different from computing device 12. However, computing device 12, or already provisioned user devices 14, may act as a wireless access point for one or more user devices 14 in alternative examples. For example, computing device 12 may transmit the unique provisioning information via Bluetooth, and user devices 14 may wirelessly connect back to computing device 12 using wireless networking protocols such as one of the IEEE 802.11 standards or any other protocol to access network 20 and server 22 to perform the self-provisioning process. In another example, computing device 12 may use the same communication protocol to transmit the provisioning information to a user device 14 and allow the user device to subsequently access network 20. In any case, computing device 12 may be configured to act as a wireless access point for network 20 in some examples. In other examples, computing device 12 may utilize an already provisioned user device 14 as an access point to a wireless network (e.g., network 20). Subsequent new user devices 14 may then identify computing device 12 over network 20 and obtain provisioning information over network 20 instead of, or in addition to, the wireless device-to-device communication established by computing device 12.

Retrieval of data from server 22 and/or repository 24, or transmission of data to such devices, during the provisioning process may require a connection between user devices 14 and networked server 22 using network 20. Both user devices 14 and networked server 22 may connect to network 20. Network 20 may be embodied as one or more of the Internet, a wireless network, a wired network, a cellular network, or a fiber optic network. In other words, network 20 may be any data communication protocol or protocols that facilitate data transfer between two or more devices. Networked server 22 may also connect to repository 24 for storing account information (e.g., owner accounts, user accounts, etc.) and/or applications or other information associated with such accounts and that may be used when each of user devices 14 are configuring themselves during the provisioning process.

Networked server 22 and repository 24 may each include one or more servers or databases, respectively. In this manner, networked server 22 and repository 24 may be embodied as any hardware necessary to provide information to each of user devices 14 during after receiving the respective unique provisioning information from computing device 12. Networked server 22 may include one or more servers, desktop computers, mainframes, minicomputers, or other computing devices capable of executing computer instructions and storing data. In some examples, functions attributable to networked server 22 herein may be attributed to respective different servers for respective functions. Repository 24 may include one or more memories, repositories, hard disks, or any other data storage device. In some examples, repository 24 may be included within networked server 22.

Repository 24 may be included in, or described as, cloud storage. In other words, account information or other information associated with owner and/or user accounts may be stored in one or more locations in the cloud (e.g., one or more repositories 24). Networked server 22 may access the cloud and retrieve the appropriate applications or setting values, for example, corresponding to the owner and/or user accounts of each user device 14. In some examples, repository 24 may include Relational Database Management System (RDBMS) software. In one example, repository 24 may be a relational database and accessed using a Structured Query Language (SQL) interface that is well known in the art. Repository 24 may alternatively be stored on a separate networked computing device and accessed by networked server 22 through a network interface or system bus. Repository 24 may in other examples be an Object Database Management System (ODBMS), Online Analytical Processing (OLAP) database or other suitable data management system.

Various aspects of the disclosure may be operable only when respective users have explicitly enabled such functionality. For example, in the instance where the user has consented to the use of any data, e.g., a user account for provisioning a respective user device, the data may be used to configure the respective user device for future use by the user. The user may consent or revoke consent to the collection and/or transmission of any data at any time.

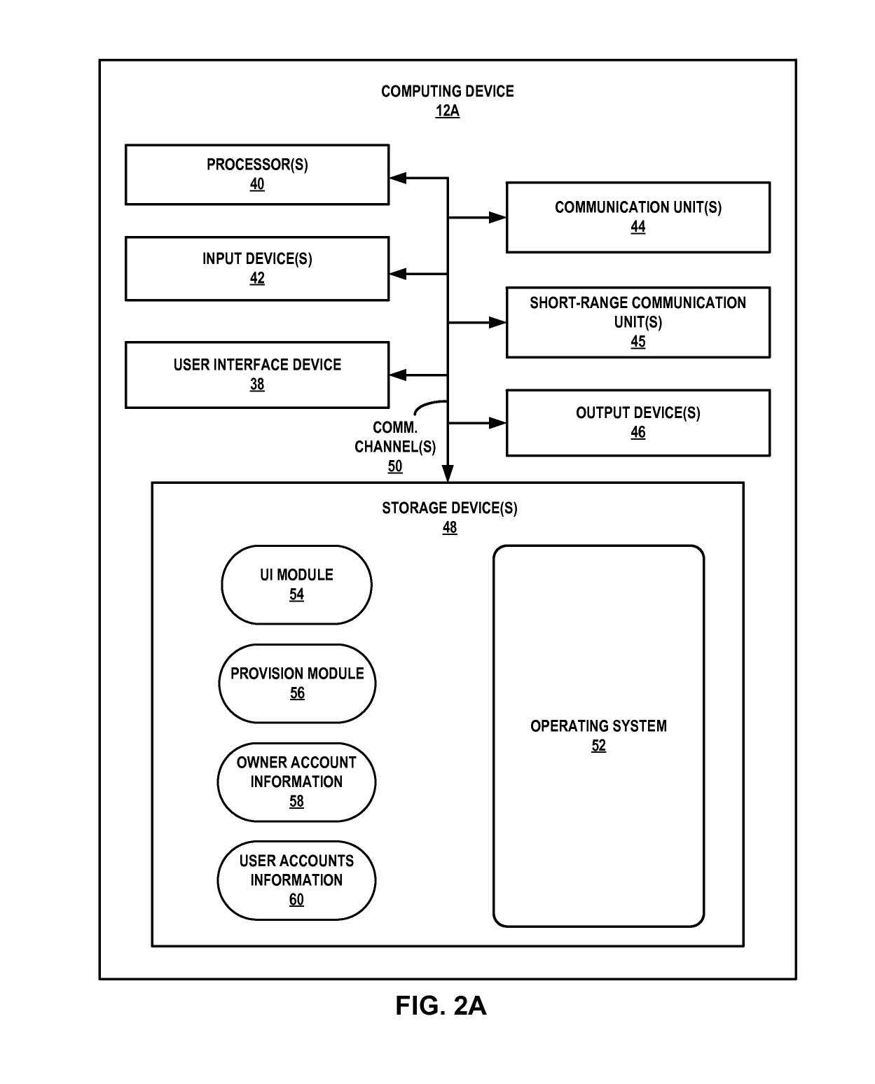

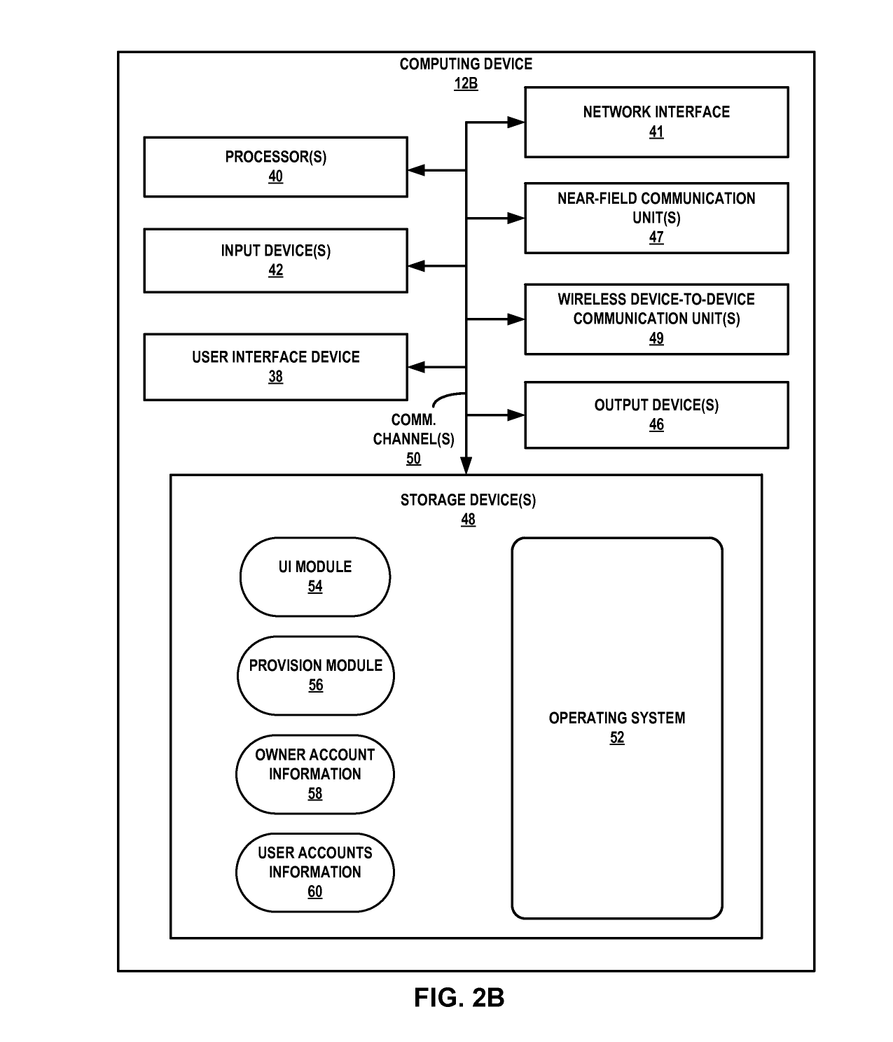

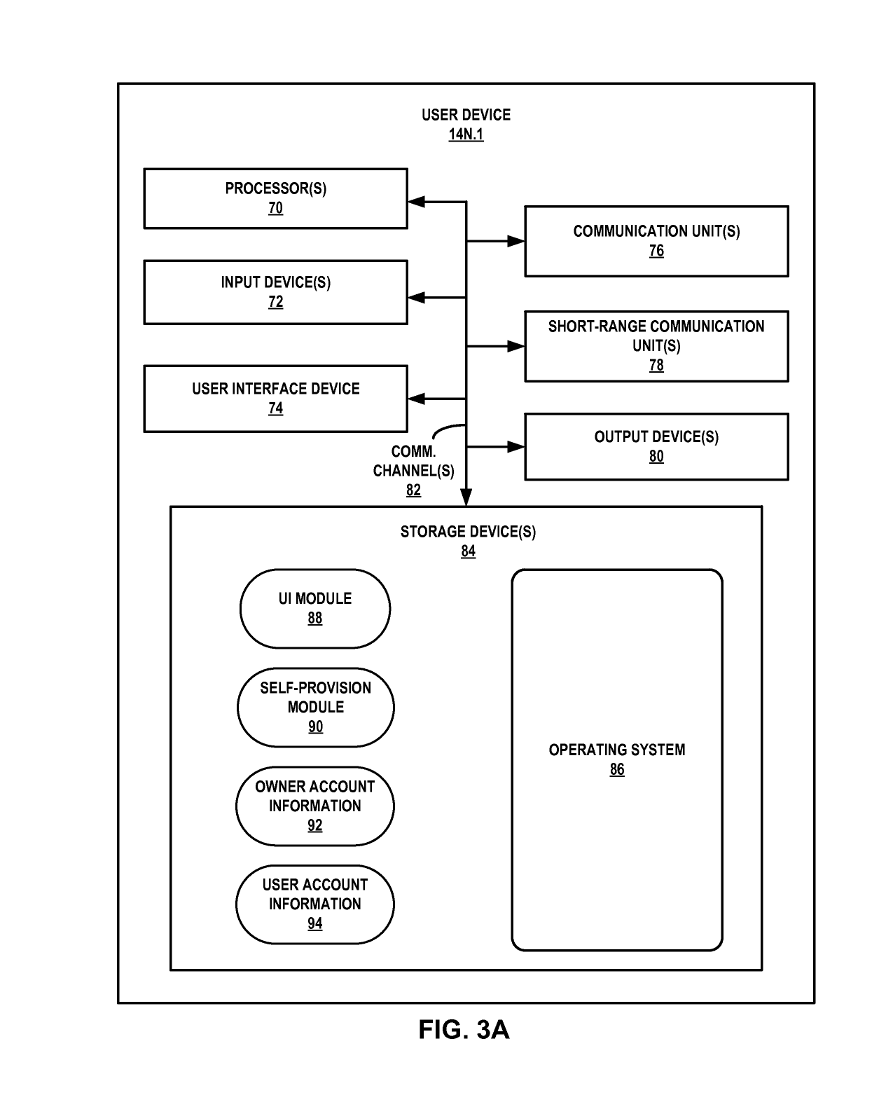

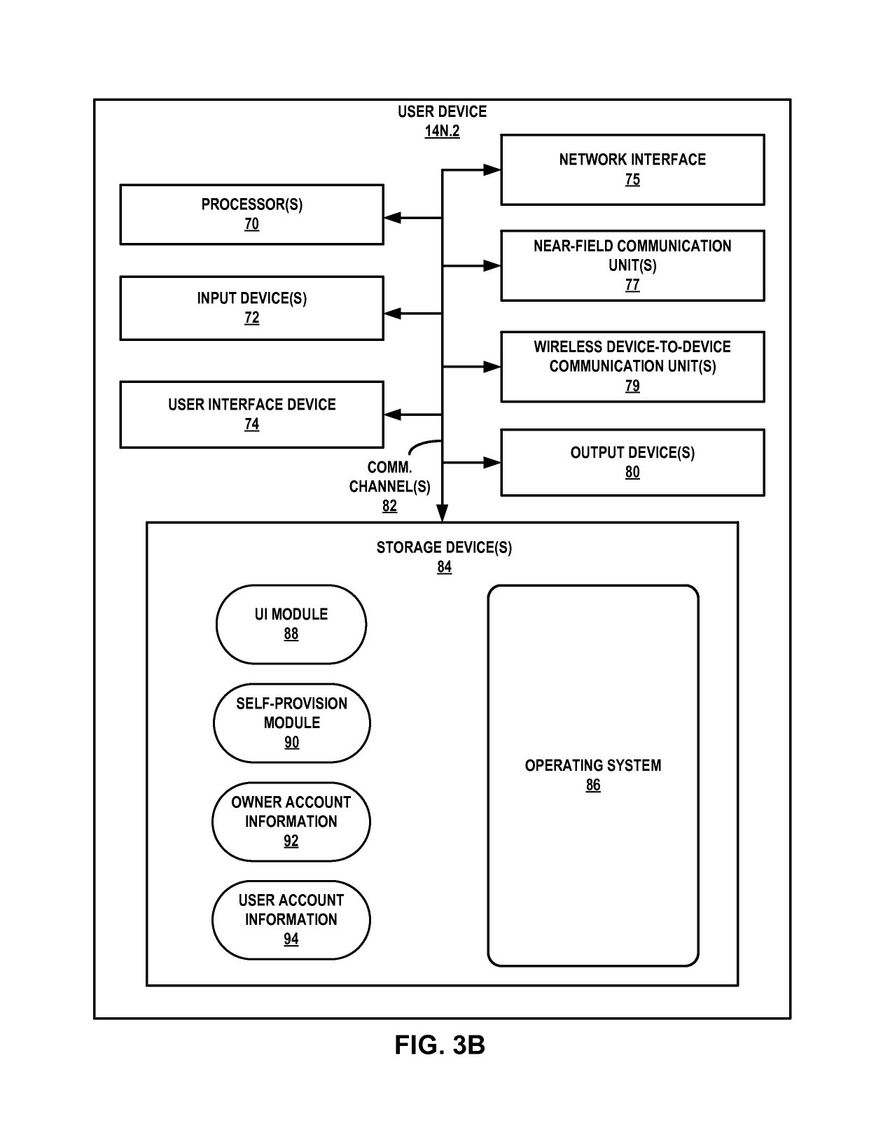

In addition, various aspects of the disclosure may be disabled by the user. Thus, a user may elect to prevent an associated user device 14 from collection and/or transmitting information associated with the user device, obtained images, or any other information related to the actions of the user device. In addition, the user may prevent a user device from transmitting information identifiable of the user without confirmation. Moreover, an administrator for an entity of the owner account associated with each user device 14 may similarly consent to the use of any data and/or revoke consent to the use of such data for one or more of the users. User devices 14 may present one or more respective screens requesting that the user elect to transmit any or all information. In this manner, the user may control what information, if any, is transmitted to a network server or other computing device. More generally, privacy controls may be applied to all aspects of the disclosure based on a user's privacy preferences to honor the user's, or administrator's privacy preferences related to the use of computing device 12, any user device 14, or any other computing device or functionality described in this disclosure. Computing device 12 may refer to any computing devices described herein, such as computing device 12A of FIG. 2A or computing device 12B of FIG. 2B. User device 14A, 14B, and 14N may refer to any of the examples of user device 14N.1 of FIG. 3A or user device 14N.2 of FIG. 3B.

FIG. 2A is a block diagram of the example administrator computing device 12 of FIG. 1. Computing device 12A of FIG. 2 is described below within the context of FIG. 1 and as merely one example of computing device 12 of FIG. 1 and elsewhere herein. In other examples, computing device 12A can include fewer, additional, or different components compared to those illustrated in FIG. 2A. For example, although user interface device 38 (“UID 38”) is shown in FIG. 2A as being integral with computing device 12A, in other implementations, UID 38 may be operably coupled to computing device 12A, e.g., by a wired or wireless data connection.

As shown in the example of FIG. 2A, computing device 12A includes UID 38, one or more processors 40, one or more input devices 42, one or more communication units 44, short-range communication unit(s) (Bluetooth units) 45, one or more output devices 46, and one or more storage devices 48. In this example, storage devices 48 of computing device 12A also various modules and information such as UI module 54, provision module 56, owner account information 58, user accounts information 60, and operating system 52. Communication channels 50 may interconnect each of the components 40, 42, 44, 45, 46, 48, 52, 54, 56, 58, and 60 for inter-component communications (physically, communicatively, and/or operatively). In some examples, communication channels 50 may include a system bus, a network connection, an inter-process communication data structure, or any other method for communicating data.

One or more input devices 42 of computing device 12A may receive input. Examples of input are tactile, audio, and video input. Input devices 42 of computing device 12A, in one example, includes a presence-sensitive display, touch-sensitive screen, mouse, keyboard, voice responsive system, video camera, microphone or any other type of device for detecting input from a human or machine. A presence-sensitive display may include both a presence-sensitive input device and a display device. In addition, input devices 42 may include one or more optical sensors, such as a digital camera. The one or more optical sensors may obtain images of visual representations of confirmation input from user devices, for example. A microphone may obtain audio information when activated by computing device 12A.

In one example, input devices 42 may include rear and/or front facing cameras configured to capture images (e.g., still images and/or video) of the environment surrounding computing device 152 such as people, landscapes, objects, or visual representations presented by other computing devices. Each camera may include one or more optical sensors capable of generating high-resolution images. For example, the optical sensor may include more than one million pixels (a one megapixel sensor), more than five million pixels (a five megapixel sensor), or even more than ten million pixels (a ten megapixel sensor). In some examples, computing device 12A may include two or more cameras disposed on any surface of computing device 12A or coupled to computing device 12A using a cable.

One or more output devices 46 of computing device 12A may generate output. Examples of output are tactile, audio, and video output. Output devices 46 of computing device 12A, in one example, a display device such as a presence-sensitive display (which may include a display device), sound card, video graphics adapter card, speaker, cathode ray tube (CRT) monitor, liquid crystal display (LCD), or any other type of device for generating output to a human or machine.

One or more communication units 44 of computing device 12A may communicate with external devices (e.g., a networked server such as networked server 22 of FIG. 1) via one or more networks (e.g., network 20 of FIG. 1) by transmitting and/or receiving network signals on the one or more networks. For example, computing device 12A may use communication unit 44 to transmit and/or receive radio signals on a radio network such as a cellular radio network. Likewise, communication units 44 may transmit and/or receive satellite signals on a satellite network such as a GPS network. Examples of communication unit 44 include a network interface card (e.g. such as an Ethernet card), an optical transceiver, a radio frequency transceiver, a GPS receiver, or any other type of device that can send and/or receive information. Other examples of communication units 44 may include Bluetooth®, GPS, 3G, 4G, and Wi-Fi® radios found in mobile devices as well as Universal Serial Bus (USB) controllers.

Short-range communication unit 45 may be configured to transmit and/or receive communication signals in accordance with short-range protocols, such as Bluetooth protocols. Short-range communication unit 45 may be configured with a power to reach, or be limited to, a desired range for communication. In other examples, short-range communication unit 45 may be configured to operate as an NFC module. Although short-range communication unit 45 may be different than communication units 44, communication units 44 may include short-range communication unit 45 in other examples.

UID 38 of FIG. 2A may include a presence-sensitive display. Computing device 12A may use the presence-sensitive display as an input device and an output device. For example, the presence-sensitive display of UID 38 may include a touchscreen (e.g., a presence-sensitive input device) configured to receive tactile user input from a user of computing device 12A. The presence-sensitive display of UID 38 may also include a light emitting diode (LED) display (e.g., a display device) capable of outputting visible information to the user of computing device 12A. UID 38 may present a user interface on the presence-sensitive display, which may be related to functionality provided by computing device 12A (e.g., transmitting unique provisioning information to respective user computing devices). For example, the presence-sensitive display of UID 38 may present various functions and applications, such as lists of user accounts, applications related to management and control of one or more user device, or any other functions related to the use of computing device 12A by an administrator for an entity. In another example, the presence-sensitive display of UID 38 may present a menu of options related to the function and operation of computing device 12A, such as screen brightness and other configurable device settings.

In some examples, the presence-sensitive display may detect an object at and/or near the screen of the presence-sensitive display. As one non-limiting example range, a presence-sensitive display may detect an object, such as a finger or stylus, which is within 2 inches or less of the physical screen of the presence-sensitive display. The presence-sensitive display may determine a location (e.g., an (x,y) coordinate) of the presence-sensitive display at or near which the object was detected. In another non-limiting example range, a presence-sensitive display may detect an object 6 inches or less from the physical screen of the presence-sensitive display, and other exemplary ranges are also possible. The presence-sensitive display may determine the location selected by the object (e.g., user's finger) using capacitive, inductive, and/or optical recognition techniques. In some examples, the presence-sensitive display provides output using tactile, audio, or video stimuli as described with respect to output device 46.

One or more storage devices 48 within computing device 12A may store information required for use during operation of computing device 12A. Storage devices 48, in some examples, have the primary purpose of being short term and not long-term computer-readable storage mediums. Storage devices 48 on computing device 12A may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Storage devices 48 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 48 may store program instructions and/or data associated with UI module 54, provision module 56, owner account information 58, user accounts information 60, operating system 52, or any other information or data related to the provisioning of user devices as described herein.

One or more processors 40 may implement functionality and/or execute instructions within computing device 12A. For example, processors 40 on computing device 12A may read and execute instructions stored by storage devices 48 that execute the functionality of UI module 54 and provision module 56. These instructions executed by processors 40 may cause computing device 12A to store information within storage devices 48 during program execution, such as notifications, notification objects, and/or information associated with provision module 56. Processors 40 may execute instructions of modules 54, 56, 58, and 60 to transmit unique provisioning information to and/or manage each of a plurality of user computing devices (e.g., user devices 14 of FIG. 1). That is, modules 54, 56, 58, and 60 may be operable by processors 40 to perform various actions, including generating and transmitting unique provisioning information. In other examples, one or more processors 40 may execute instructions of any of modules 54, 56, 58, and 60 to request a networked server to at least partially perform any of the functions attributed to modules 54, 56, 58, and 60 herein.

UI module 54 may control the graphical user interface that is presented by a display device or other components of output devices 46. For example, UI module 54 may output graphical information to represent the received account information, user accounts and/or user devices that have received provisioning information, status information regarding the transfer of provisioning information and/or the subsequent self-provisioning of each user device, or any other information related to the features described herein.

Provision module 56 may perform the functionality described herein with regard to initiating the provisioning process for each user device, such as obtaining user account information, lists of device identifiers, controlling the broadcast of a provisioning service via short-range communication, comparing device identifiers, transmitting provisioning information, generating provisioning information, or any other features described herein. For example, provisioning module 56 may manage the receipt of account information (e.g., from server 22 or some other source of the user and/or owner account), generation of unique provisioning information, broadcasting a provisioning service via short-range communication, sensing when a user device 14 is in communication range of computing device 12A, and/or transmitting the unique provisioning information to the user device in communication range of computing device 12A. Provisioning module 56 may perform these functions, and any other functions related to the provisioning process, based on instructions stored in storage devices 48 or obtainable via network 20. In this manner, provisioning module 56 may control computing device through the provisioning process of transmitting unique provisioning information to respective user devices. Provisioning module 56 may also, in some examples, manage the collection of data and management of the result of the self-provisioning performed by each user device.

Owner account information 58 may store an indication of one or more owner accounts and/or copies of the one or more owner accounts. The owner account may be the account associated with computing device 12A and the entity that may manage the operation of each user device. Although computing device 12A may also be at least partially controlled by the owner account, computing device 12A may not be associated with the owner account in other examples. The owner account may not typically be accessed or modified by a user associated with a user account. In this manner, each user account may be subordinate to the owner account. In some examples, owner account information 58 may include one or more lists of device identifiers associated with respective user devices 14.

User accounts information 60 may include a plurality of accounts associated with respective users. Typically, one user account may be associated with a single user. However, one user account may be associated with two or more users that will share use of the user device to be configured with the user account. User accounts information 60 may be stored as a list or in another database, and user accounts information 60 may store indicates of each user account, various information regarding the user account (e.g., the associated user, classes to which the user is enrolled, supervisor(s) for the user, a type of user device to be provisioned with the user account, or any other associated information). In some examples, one or more user accounts may be associated with a device identifier prior to communication between computing device 12A and user device 14.

In some examples, storage devices 48 may also store device policy information that sets one or more limitations on functionalities of the user devices and/or user accounts. The device policy information may be associated or tied to the owner account to maintain consistent settings across some or all of the user devices. In other examples, each of two or more device policies may be associated with respective user accounts. Although each set of unique provisioning information may include an indication of each of an owner account, a user account, and device policy information, other examples of provisioning information may include more or less data.

Although the components of computing device 12A are illustrated in the example of FIG. 2A as within a common housing, one or more components may instead be wired or wirelessly tethered to computing device 12A. For example, output device 46 (e.g., a display device) may be physically separate from computing device 12A. In other examples, an optical sensor may not reside within a housing of computing device 12A.

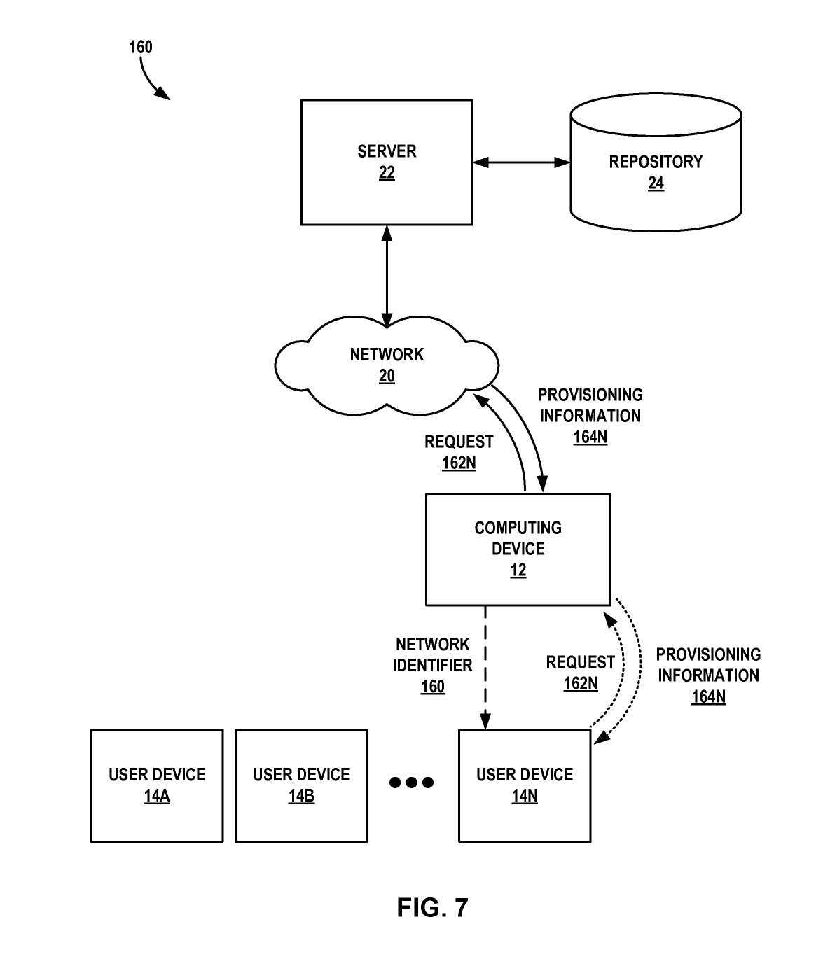

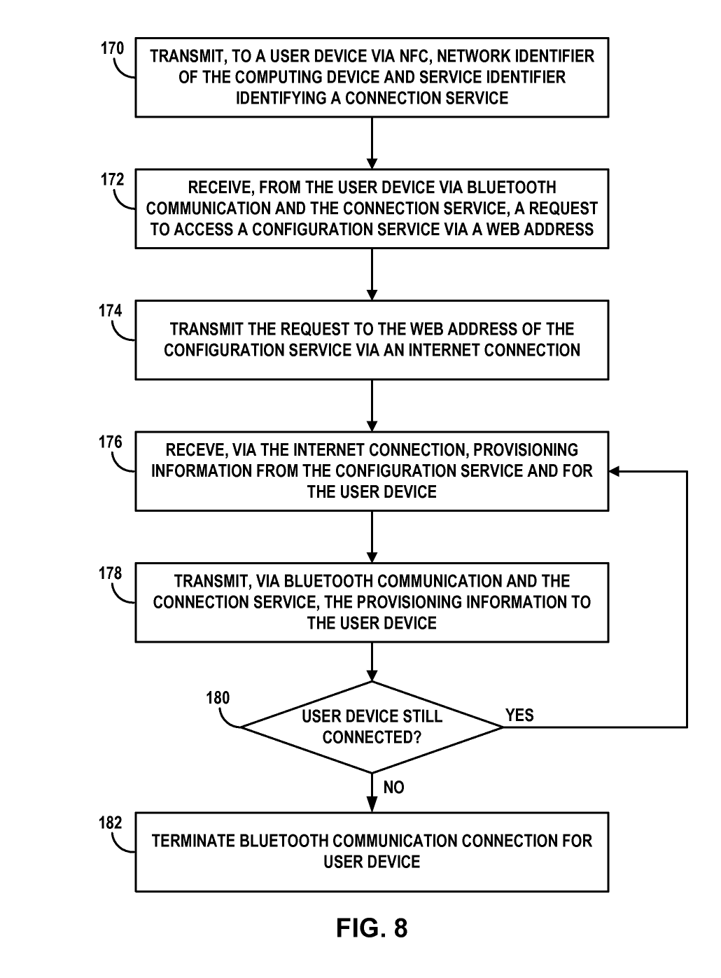

FIG. 2B is a block diagram of another example administrator computing device 12B. Computing device 12B of FIG. 2 is described below and in the example of FIG. 7 as merely one example of computing device 12. In other examples, computing device 12B can include fewer, additional, or different components compared to those illustrated in FIG. 2B. Computing device 12B may be substantially similar to computing device 12A of FIG. 2A. However, computing device 12B may include different communication hardware, software, or other components that may support a configuration of computing device 12 as described in FIGS. 7 and 8, for example.

As shown in the example of FIG. 2B, computing device 12B includes network interface 41, one or more near-field communication unit(s) 47, and one or more wireless device-to-device communication units 49 instead of communication units 44 and short-range communication units 45 of computing device 12A of FIG. 2A. In some examples, network interface 41, near-field communication unit(s) 47, and/or wireless device-to-device communication units 49 may be included within one or both of communication units 44 or short-range communication units 45.

Network interface 41 may be configured to communicate with external devices (e.g., a networked server such as networked server 22 of FIG. 1 or 7) via one or more networks (e.g., network 20 of FIG. 1) by transmitting and/or receiving network signals on the one or more networks. For example, computing device 12B may control network interface 41 to connect with a wireless access point or other device in order to establish an Internet connection (e.g., access to the World Wide Web, cloud service, or any other networked devices). In one example, network interface 41 may include one or more Wi-Fi® radios for establishing a wireless Internet connection using a Wi-Fi protocol such as according to one or more IEEE 802.11 protocols. In another example, network interface 41 may include a 3G, 4G, or other radio configured to transmit and/or receive radio signals on a radio network such as a cellular radio network. Other examples of network interface 41 may include a network interface card (e.g. such as an Ethernet card), an optical transceiver, a radio frequency transceiver, or any other type of device that can send and/or receive information to establish an Internet and/or intranet connection. As described herein, the Internet connection may be used to transmit information to and receive information from a configuration service.

One or more near-field communication units 47 may include one or more units configured to transmit and/or receive communication signals in accordance with a near-field communication (NFC) protocol. The one or more near-field communication units 47 may be referred to below a single unit, although multiple units may be used in these examples as well. Near-field communication unit 47 may be configured with a power to reach, or be limited to, a desired range for communication. In this manner, near-field communication unit 47 may include an NFC module configured to operate as an active NFC module. NFC may operate over relatively short distances, such as a distance no more than approximately 1 meter, no more than approximately 10 centimeters, or even no more than approximately 1 centimeter. As described herein, near-field communication unit 47 may be used to transmit information (e.g., a network identifier and/or service identifier of a wireless device-to-device communication connection) in response to sensing a user device (e.g., user device 14N.2) within near-field communication range.

One or more wireless device-to-device communication units 49 may include one or more units configured to transmit and/or receive communication signals directly between two devices over a device-to-device communication connection. In one example, wireless device-to-device communication units 49 may include one or more units configured to transmit and/or receive communication signals according to a Bluetooth protocol. A Bluetooth protocol may define communications within a frequency range of 2400-2483.5 MHz and implement a frequency-hopping spread spectrum. The transmitted data over the Bluetooth connection may be divided into packets and transmitted over a plurality of designated channels (e.g., 79 channels in one example). Wireless device-to-device communication units 49 may broadcast a connection that is accessible to one or more other devices (e.g., any of user devices 14A, 14B, or 14N). Wireless device-to-device communication units 49 may include a network identifier that is unique to the specific wireless device-to-device communication units 49 of computing device 12B. Once another computing device (e.g., user device 14N) obtains the network identifier, the other computing device may establish the wireless device-to-device communication connection between computing device 12B and the other computing device.

Wireless device-to-device communication units 49 may be configured to maintain connections with multiple other computing devices simultaneously. For example, wireless device-to-device communication units 49 may be configured to maintain connections with up to 30 or more devices at the same time. In this manner, wireless device-to-device communication units 49 may allow computing device 12B to channel information to and from multiple user devices simultaneously until each user device has obtained the necessary provisioning information from the configuration service.

Provision module 56 may perform the functionality described herein (e.g., in reference to FIG. 2A or 2B) such as transmitting network identifiers, service identifiers, web addresses of configuration services, unique user account information, and/or unique device identifiers to user devices. Provision module 56 may also perform tasks such as establishing an Internet proxy to channel data from user devices over the wireless device-to-device communication connection to network interface 41 and vice versa. Provision module 56 may thus control tasks related to provisioning user devices. User accounts information 60 may include indications of one or more unique user accounts and/or unique device identifiers for user devices to be provisioned. In alternative examples, computing device 12B may not include any user account information 60 that is unique to any one user account.

FIG. 3A is a block diagram of example user device 14N of FIG. 1. User device 14N.1 of FIG. 3A is just one example of user device 14N and is described below within the context of FIG. 1. User device 14N.1 is an example of user devices 14 of FIG. 1, and other user devices 14 may include similar components and perform similar functions. In addition, user device 14N.1 may have similar components to that of computing devices 12A or 12B of FIGS. 1 and 2. User device 14N.1 can include fewer, additional, or different components compared to those illustrated in FIG. 3A. For example, although user interface device 74 (“UID 74”) is shown in FIG. 3A as being integral with user device 14N.1, in other implementations, UID 74 may be operably coupled to user device 14N.1, e.g., by a wired or wireless data connection.

As shown in the example of FIG. 3A, user device 14N.1 includes UID 74, one or more processors 70, one or more input devices 72, one or more communication units 76, short-range communication unit(s) (Bluetooth units) 78, one or more output devices 80, and one or more storage devices 84. In this example, storage devices 84 of user device 14N.1 also various modules and information such as UI module 88, self-provision module 90, owner account information 92, user account information 94, and operating system 86. Communication channels 82 may interconnect each of the components 70, 72, 76, 78, 80, 84, 86, 88, 56, 92, and 94 for inter-component communications (physically, communicatively, and/or operatively). In some examples, communication channels 82 may include a system bus, a network connection, an inter-process communication data structure, or any other method for communicating data.

One or more input devices 72 of computing device 12 may receive input. Examples of input are tactile, audio, and video input. Input devices 72 of computing device 12, in one example, includes a presence-sensitive display, touch-sensitive screen, mouse, keyboard, voice responsive system, video camera, microphone or any other type of device for detecting input from a human or machine. A presence-sensitive display may include both a presence-sensitive input device and a display device. In addition, input devices 72 may include one or more optical sensors, such as a digital camera. A microphone may obtain audio information when activated by user device 14N.1.

In one example, input devices 72 may include rear and/or front facing cameras configured to capture images (e.g., still images and/or video) of the environment surrounding computing device 186 such as people, landscapes, objects, or visual representations presented by other computing devices. Each camera may include one or more optical sensors capable of generating high-resolution images. For example, the optical sensor may include more than one million pixels (a one megapixel sensor), more than five million pixels (a five megapixel sensor), or even more than ten million pixels (a ten megapixel sensor). In some examples, user device 14N.1 may include two or more cameras disposed on any surface of user device 14N.1 or coupled to user device 14N.1 using a cable.

One or more output devices 80 of user device 14N.1 may generate output. Examples of output are tactile, audio, and video output. Output devices 80 of user device 14N.1, in one example, a display device such as a presence-sensitive display (which may include a display device), sound card, video graphics adapter card, speaker, cathode ray tube (CRT) monitor, liquid crystal display (LCD), or any other type of device for generating output to a human or machine.

One or more communication units 76 of user device 14N.1 may communicate with external devices (e.g., a networked server such as networked server 22 of FIG. 1) via one or more networks (e.g., network 20 of FIG. 1) by transmitting and/or receiving network signals (e.g., retrieve applications and/or transmit provisioning-related information during the self-provisioning process) on the one or more networks. For example, user device 14N.1 may use communication unit 76 to transmit and/or receive radio signals on a radio network such as a cellular radio network. Likewise, communication units 76 may transmit and/or receive satellite signals on a satellite network such as a GPS network. Examples of communication unit 76 include a network interface card (e.g. such as an Ethernet card), an optical transceiver, a radio frequency transceiver, a GPS receiver, or any other type of device that can send and/or receive information. Other examples of communication units 76 may include Bluetooth®, GPS, 3G, 4G, and Wi-Fi® radios found in mobile devices as well as Universal Serial Bus (USB) controllers.

Short-range communication unit 78 may be configured to transmit and/or receive communication signals in accordance with Bluetooth protocols. In other examples, short-range communication unit 78 may be configured to operate according to NFC protocols. Although short-range communication unit 78 may be different than communication units 76, communication units 76 may include short-range communication unit 78 in other examples.

UID 74 of FIG. 3A may include a presence-sensitive display. User device 14N.1 may use the presence-sensitive display as an input device and an output device. For example, the presence-sensitive display of UID 74 may include a touchscreen (e.g., a presence-sensitive input device) configured to receive tactile user input from a user of user device 14N.1. The presence-sensitive display of UID 74 may also include a light emitting diode (LED) display (e.g., a display device) capable of outputting visible information to the user of user device 14N.1. UID 74 may present a user interface on the presence-sensitive display, which may be related to functionality provided by user device 14N.1 (e.g., presenting status updates for the self-provisioning process).

One or more storage devices 84 within user device 14N.1 may store information required for use during operation of user device 14N.1. Storage devices 84, in some examples, have the primary purpose of being short term and not long-term computer-readable storage mediums. Storage devices 84 on user device 14N.1 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Storage devices 84 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 84 may store program instructions and/or data associated with UI module 88, self-provision module 90, owner account information 92, user accounts information 94, operating system 86, or any other information or data related to the provisioning of user devices as described herein.

One or more processors 70 may implement functionality and/or execute instructions within user device 14N.1 (or other user devices to self-provision themselves). For example, processors 70 on user device 14N.1 may read and execute instructions stored by storage devices 84 that execute the functionality of UI module 88 and self-provision module 90. These instructions executed by processors 70 may cause user device 14N.1 to store information within storage devices 84 during program execution, such as notifications, notification objects, and/or information associated with self-provision module 90. Processors 70 may execute instructions of modules 88, 56, 92, and 94 to receive and store unique provisioning information for subsequent self-provisioning activities such as retrieving applications and/or setting values associated with one or more accounts of the unique provisioning information. That is, modules 88, 56, 92, and 94 may be operable by processors 70 to perform various actions, including receiving unique provisioning information and conducting the self-provisioning process. In other examples, one or more processors 70 may execute instructions of any of modules 88, 56, 92, and 94 to request a networked server to at least partially perform any of the functions attributed to modules 88, 56, 92, and 94 herein.

UI module 88 may control the graphical user interface that is presented by a display device or other components of output devices 80. For example, UI module 88 may output graphical information to represent the received unique provisioning information, network 20 access status, applications and/or setting values retrieved from sever 22, or any other activities related to the self-provisioning functions of user device 14N.1. In addition, UI module 88 may control the graphical user interface according to any other applications or instructions during use of user device 14N.1 by the associated user.

Self-provision module 90 may perform the functionality described herein with regard to the self-provisioning process performed in response to receiving the unique provisioning information from computing device 12. The self-provisioning process is the process in which self-provisioning module 90 of user device 14N.1 performs automatic configuration of user device 14N.1 in accordance with the received unique provisioning information. For example, based on the instructions of the unique provisioning information, self-provisioning module 90 may control user device 14N.1 to connect to network 20 and retrieve one or more applications, setting values, or any other information from sever 22 and/or repository 24. Self-provisioning module 90 may install any software components, applications, or other modules based on the retrieved applications or setting values. Self-provisioning module 90 may also be configured to detect there is not user account set-up on user device 14N.1, initiate short-range communication, detect computing device 12, transmit device identifier 15N, control encryption of device identifiers, authenticate computing device 12, or any other function described herein related to the provisioning process.

When self-provisioning module 90 completes the self-provisioning process, user device 14N.1 may have been changed from a generic user device with generic software to a user-specific device with user-specific software ready for use by the end-user. In other words, prior to the self-provisioning process being performed on any device, the data and/or software stored on user device 14N.1 may be substantially identical to the data and/or software stored on any other user devices 14 (e.g., user devices 14A and 14B). After each user device 14 performs the self-provisioning process, each of user devices 14 may have different data and/or software that are personalized to the user account indicated by the respective unique provisioning information.

Owner account information 92 may store an indication of the owner account associated with user device 14N.1. In some examples, owner account information 92 may also store one or more setting values that controls, enables, or limits various functions of user device 14N.1. User account information 94 may store an indication of the user account associated with the user of user device 14N.1. Although user device 14N.1 may be associated with only one user account in some examples, user device 14N.1 may be associated with two or more user accounts in other examples. User device 14N.1 may confine each of the multiple user accounts to separate operating environments (e.g., user device 14N.1 may only operate according to one user account at a time). User account information 94 may store one or more setting values that controls, enables, or limits, various functions, applications, or any other services executable by user device 14N.1. In response to any changes that the user makes to user account information 94, user device 14N.1 may communicate with server 22 via network 20 to reflect user account information stored in repository 24.

Storage devices 84 may also store device policy information that sets one or more limitations on functionalities of user device 14N.1. The device policy may set various settings to control what functions are available or blocked for the user. In this manner, the device policy may be managed by the owner account and used to limit what components are enabled (e.g., one or more cameras) and/or what functionalities are available to the user. In some examples, the device policy may be associated with the owner account such that any changes to the owner account may be reflected in the device policy. The device policy may be transmitted to user device 14N.1 as part of the unique provisioning information or retrieved from server 22 during the self-provisioning process.

Although the components of user device 14N.1 are illustrated in the example of FIG. 3A as within a common housing, one or more components may instead be wired or wirelessly tethered to user device 14N.1. For example, output devices 80 (e.g., a display device) may be physically separate from user device 14N.1. In other examples, an optical sensor may not reside within a housing of user device 14N.1.

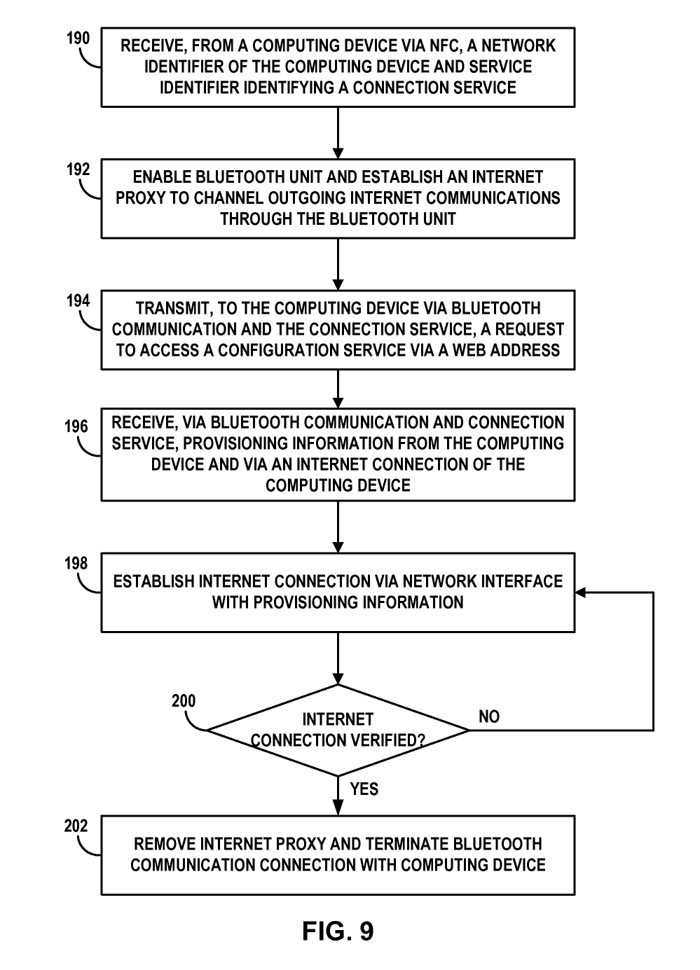

FIG. 3B is a block diagram of example user device 14N.2. User device 14N.2 of FIG. 3B is described below within the context of FIGS. 7, and 9, for example. User device 14N.2 is just one example of user devices 14 of FIG. 1 and FIG. 7, and other user devices 14 may include similar components and perform similar functions. In other examples, user device 14N.2 can include fewer, additional, or different components compared to those illustrated in FIG. 3B. User device 14N.2 may be substantially similar to user device 14N.2 of FIG. 3A. However, user device 14N.2 may include different communication hardware, software, or other components that may support a configuration of user device 14 as described in FIGS. 7 and 9, for example.

As shown in the example of FIG. 3B, user device 14N.2 includes network interface 74, near-field communication unit(s) 77, and wireless device-to-device communication units 79 instead of communication units 76 and short-range communication units 78 of user device 14N.1 of FIG. 3A. In some examples, network interface 75, near-field communication unit(s) 77, and/or wireless device-to-device communication units 79 may be included within one or both of network interface 76 or short-range communication units 78 of user device 14N.1.

Network interface 75 may be configured to communicate with external devices (e.g., a networked server such as networked server 22 of FIG. 1 or 7) via one or more networks (e.g., network 20 of FIG. 1) by transmitting and/or receiving network signals on the one or more networks. For example, user device 14N.2 may control network interface 75 to connect with a wireless access point or other device in order to establish an Internet connection (e.g., access to the World Wide Web, cloud service, or any other networked devices). In one example, network interface 75 may include one or more Wi-Fi® radios for establishing a wireless Internet connection using a Wi-Fi protocol such as according to one or more IEEE 802.11 protocols. In another example, network interface 75 may include a 3G, 4G, or other radio configured to transmit and/or receive radio signals on a radio network such as a cellular radio network. Other examples of network interface 75 may include a network interface card (e.g. such as an Ethernet card), an optical transceiver, a radio frequency transceiver, or any other type of device that can send and/or receive information to establish an Internet and/or intranet connection. As described herein, the Internet connection may be used to self-provision user device 14N.2.

Near-field communication units 77 may include one or more units configured to transmit and/or receive communication signals in accordance with a near-field communication (NFC) protocol. The one or more near-field communication units 77 may be referred to below a single unit, although multiple units may be used in these examples as well. Near-field communication unit 77 may be configured with a power to reach, or be limited to, a desired range for communication. In this manner, near-field communication unit 77 may include an NFC module configured to operate as an active NFC module. NFC may operate over relatively short distances, such as, for instance, a distance no more than approximately 1 meter, no more than approximately 10 centimeters, or even no more than approximately 1 centimeter. As described herein, near-field communication unit 77 may be used to receive information (e.g., a network identifier and/or service identifiers of a wireless device-to-device communication connection) from an administrator device within near-field communication range.

Wireless device-to-device communication units 79 may include one or more units configured to transmit and/or receive communication signals directly between two devices over a device-to-device communication connection. In one example, wireless device-to-device communication units 79 may include one or more units configured to transmit and/or receive communication signals according to a Bluetooth protocol. A Bluetooth protocol may define communications within a frequency range of 2400-2483.5 MHz and implement a frequency-hopping spread spectrum. The transmitted data over the Bluetooth connection may be divided into packets and transmitted over a plurality of designated channels (e.g., 79 channels in one example). Wireless device-to-device communication units 79 may establish a connection with a wireless device-to-device communication connection broadcast from an administrator device, such as computing device 12B. Wireless device-to-device communication units 79 may include a network identifier that is unique to the specific wireless device-to-device communication units 79 of user device 14N.2. User device 14N.2 may share the network identifier when needed to establish the connection. Wireless device-to-device communication units 79 may be configured to maintain connections with multiple other computing devices simultaneously. For example, wireless device-to-device communication units 79 may be configured to establish connections between an administrator device (e.g., computing device 12B and another user device).

Self-provision module 90 may perform the functionality described herein such as transmitting a request to obtain provisioning information from a configuration service, confirming the authenticity of an administrator device, establishing a proxy Internet connection with wireless device-to-device communication units 79, receiving network credentials, and/or receiving an indication of a unique user account. Self-provision module 90 may also perform processes such as configuring user device 14N.2 with one or more applications according to received provisioning information. User account information 94 may include an indication of one or more unique user accounts to be installed on user device 14N.2, and user device 14N.2 may populate user account information 94 from information received from an administrator device and/or provisioning information received from a configuration service. In this manner, user account information 94 may be empty or incomplete until user device 14N.2 communicates with computing device 12B and/or the configuration service.

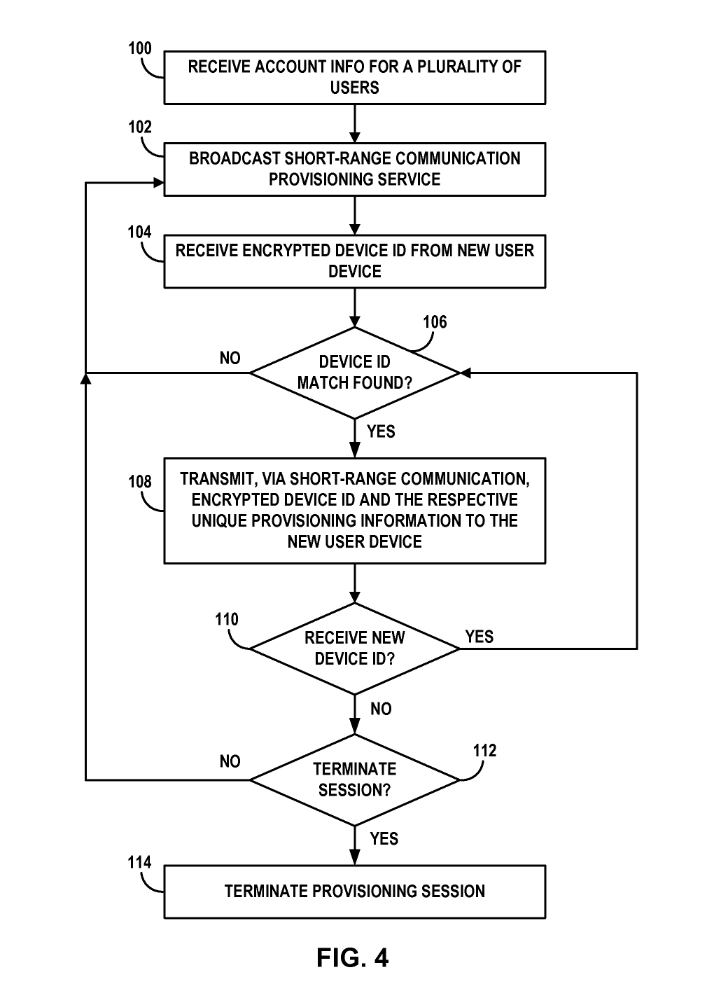

FIG. 4 is a flow diagram illustrating an example process for transmitting provisioning information to one or more user devices, in accordance with one or more aspects of the present disclosure. An administrator computing device, such as computing device 12 described in FIGS. 1 and 2, may perform the process of FIG. 4. In some instances, one or more processors of a computing device, such as processors 40 (including provisioning module 56) of computing device 12 of FIGS. 1 and 2, may perform the process of FIG. 4. For purposes of illustration only, FIG. 4 is described below within the context of computing device 12 of FIGS. 1 and 2 and user device 14N of FIGS. 1 and 3.

As shown in FIG. 4, computing device 12 may be powered on and, in some examples, processors 40 may be executing a provisioning session application configured to transmit unique provisioning information to user devices. Computing device 12, via the provisioning session application, may receive various user input configuring one or more aspects of the provisioning process (e.g., select how computing device 12 will sense each user device 14 and/or select the type of wireless device-to-device communication for transmission of the provisioning information, such as Bluetooth communication) or the provisioning information (e.g., the types of information to be included in the provisioning information). Processors 40 may receive account information for a plurality of users (100). The account information may be received from server 22 via network 20, another computing device, or a predetermined list of accounts. In some examples, the account information may include or indicate respective user accounts. In addition, the account information may include an owner account for the entity that will manage at least some of the user devices. Processors 40 may also receive a list of device identifiers associated with respective user devices 14 to be provisioned. The list may be included in the account information, separate from the account information. In some examples, the account information and/or the list of device identifiers may be received outside of the execution of the provisioning session application.

In some examples, processors 40 may generate unique provisioning information for each of the plurality of users associated with the respective user accounts. Generation of each set of unique provisioning information may include creating indications of a user account, an owner account, and, in some examples, a device policy. Although processors 40 may generate sets of unique provisioning information prior sensing any user device, processors 40 may generate each set of unique provisioning information in response to sensing the respective user device.

Once computing device 12 has account information and the list of device identifiers, processors 40 may control short-range communication unit 45 to broadcast the short-range communication provisioning service (102). Broadcasting the short-range communication provisioning service may include powering on short-range communication unit 45 and transmitting a signal that user devices 14 can detect. In some examples, broadcasting the short-range communication provisioning service may include transmitting a request for non-provisioned devices to send a device identifier or otherwise initiate wireless device-to-device communication between the user device 14 and computing device 12. The short-range communication provisioning service may conform to the Bluetooth communication protocol, as discussed herein.

After processors 40 initiate the broadcast of the provisioning service, processors 40 may receive an encrypted device identifier (e.g., device ID or device identifier 15N) from the new user device 14N (104). The encrypted device identifier 14N may be a hash of the serial number of user device 14N, a representation of the device identifier after encrypted using an encryption scheme known to both user device 14N and computing device 12, or otherwise a secured representation of the identification of user device 14N. In other examples, the actual serial number or other device identifier may be received by computing device 12. Processors 40 may then compare the received device identifier 15N to the list of identifiers stored on computing device 12 or otherwise accessible (e.g., via network 20) to computing device 12 (106). If the received device identifier 15N does not match any device identifiers on the list (“NO” branch of block 106), processors 14 may ignore or discard the device identifier (e.g., the specific user device is not scheduled to be provisioned) and continue broadcasting the provisioning service for other user devices (102).

If the received device identifier 15N does match one of the device identifiers on the list (“YES” branch of block 106, processors 40 may control short-range communication unit 45 (e.g., a Bluetooth unit) to transmit a return encrypted device identifier and the respective unique provisioning information 16N to the new user device 14N (108). The return encrypted device identifier may also be a representation of the device identifier of user device 14N, but encrypted differently than device identifier 15N received from user device 14N (e.g., a different hash or different encryption of the same device identifier). User device 14N may use this return encrypted device identifier as an authentication that computing device 12 recognizes user device 14N and the provisioning of user device 14N is authorized. In other examples, processors 40 may first sent the return encrypted device identifier to complete the handshake over the wireless device-to-device communication and wait to transmit provisioning information 16 until confirmation is received from user device 14N that computing device 12 has been authenticated.

The encryption process (e.g., generating a representation of the unique device identifier according to a hash function or other encryption scheme) may be performed in any of a number of different ways. In one example, processors 40 may be configured to receive the first encrypted representation of the unique device identifier (i.e., unique identifier 15N) and decrypt the first encrypted representation to obtain the actual unique device identifier of user device 14N (e.g., a serial number identifying the user device). Processors 40 may then be configured to transmit, via the wireless device-to-device communication, a second encrypted representation of the unique device identifier (e.g., the return encrypted device identifier) to user device 14N. The first encrypted representation may be different than the second encrypted representation, and user device 14N may be configured to authenticate provisioning information 16N by decrypting the second encrypted representation and matching the decrypted second encrypted representation to the actual unique device identifier that identifies user device 14N (e.g., the serial number). Other techniques for securely transmitting unique identifiers may also be used.

If processors 40 determine that a new device identifier is received from another user device 14 (“YES” branch of block 110), processors 40 may again compare the new device identifier to the list of device identifiers (106). The processors 40 may perform the process of receiving device identifiers (104), matching device identifiers (106), and transmitting device identifiers and respective provisioning information (108) may occur simultaneously for two or more user devices 14. In other words, processors and short-range communication unit 45 may be configured to simultaneously communicate with multiple user devices. If processors 40 have not received any new device identifiers (“NO” branch of block 110), processors 40 may check to determine if the provisioning session is to be terminated, such as by receiving a user input to terminate the session (112). If the provisioning session is not to be terminated (“NO” branch of block 112), processors 40 may continue to broadcast the short-range communication provisioning service (102). If the provisioning session is to be terminated (“YES” branch of block 112), processors 40 may terminate the provisioning session (114). Even though processors 40 may terminate the provisioning session, one or more of user devices 14 may continue to configure themselves during the self-provisioning process. In some examples, computing device 12 may receive status updates related to which user devices 14 have completed the self-provisioning process and are associated with which user accounts, and computing device 12 may output those status updates for display.

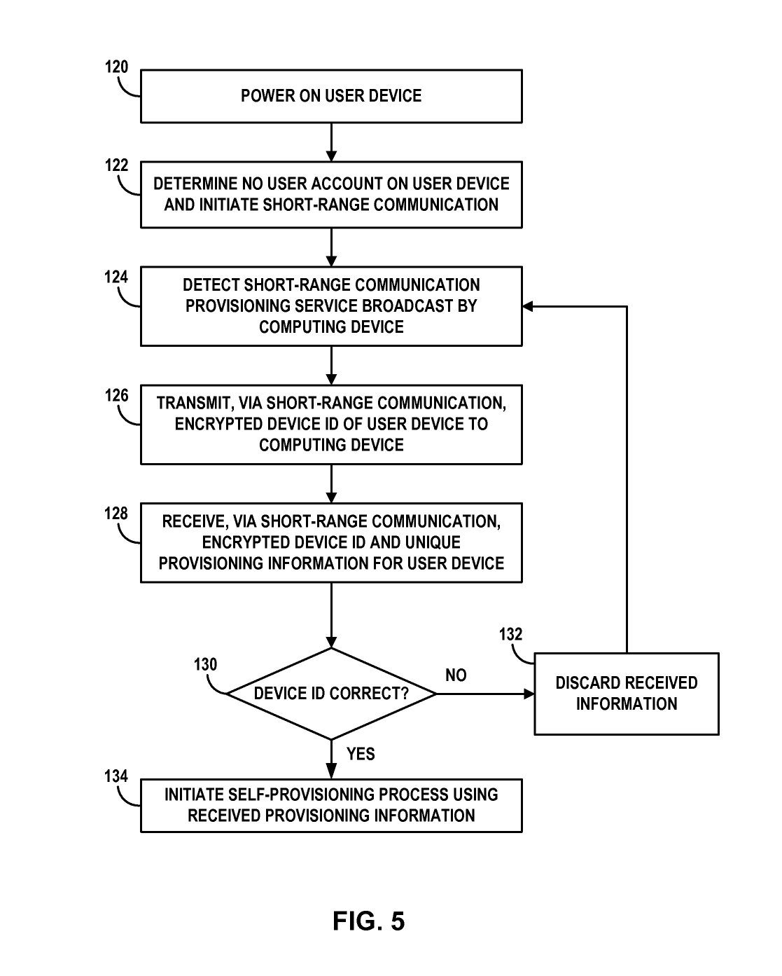

FIG. 5 is a flow diagram illustrating an example process for receiving provisioning information at a user computing device from an administrator computing device. The process of FIG. 5 may, in some cases, be similar to the process of FIG. 4, but described from the perspective of the user device (e.g., the computing device to perform the self-provisioning process) instead of the administrator computing device. A user computing device, such as user device 14 described in FIGS. 1 and 3, may perform the process of FIG. 5. In some instances, one or more processors of a computing device, such as processors 70 (including self-provision module 90) of user device 14N of FIGS. 1 and 3, may also perform the process of FIG. 5. For purposes of illustration, FIG. 5 is described below within the context of computing device 12 of FIGS. 1 and 2 and user device 14N of FIGS. 1 and 3.

As shown in FIG. 5, user device 14N may be powered on (120). Processors 70 may initially check to determine if any user account has been installed, established, or set-up on user device 14N. When user device 14N is new from the manufacturer or a factory reset has been performed on the device, for example, user device 14N may be prepared to be provisioned as described herein. Processors 70 accordingly determine that no user account is present on user device 14 and initiate, via short-range communication unit 78 (e.g., Bluetooth communication), short-range communication abilities (122).

Processors 70 then detect a short-range communication provisioning service broadcast by computing device 12 (124). If processors 70 do not detect a short-range communication provisioning service, processors 70 may continue to search or scan for a service until one is available. In response to detecting the short-range communication provisioning service, processors 70 control short-range communication unit 78 to transmit, via short-range communication (e.g., Bluetooth communication) an encrypted device identifier (e.g., device identifier 15N) representative of the unique device identifier of user device 14N to computing device 12 (126). As discussed herein, the encrypted device identifier may be a hash of a serial number or some other secure representation of a value indicative of user device 14N. In some examples, processors 70 may also transmit a request for provisioning information 16N to be sent from computing device 12.

Subsequently, processors 70 may receive, via the short-range communication, a return encrypted device identifier and unique provisioning information 16N for user device 14N and from computing device 12 (128). As discussed with regard to FIG. 4, processors 70 may first receive the return encrypted device identifier and sent a confirmation to computing device 12 that the return encrypted device identifier has been authenticated prior to receiving the unique provisioning information 16N. If processors 70 determine that the device identifier received from computing device 12 is incorrect, such as it does not match the unique device identifier of user device 14N (“NO” branch of block 132), processors 70 may discard the received provisioning information 16N and again search or scan for another short-range communication provisioning service (124). In this manner, processors 70 may be prevented from completing the self-provisioning process with unauthorized information that may compromise the security of user device 14N or otherwise interfere with the owner or user intended use of user device 14N. If processors 70 determine that the device identifier received from computing device 12 is correct (“YES” branch of block 130), processors 70 may initiate the self-provisioning process using the received provisioning information 16N from computing device 12 via short-range communication (134).

FIGS. 4 and 5 are described such that computing device 12 is configured to generate and send provisioning information unique to each of user devices 14. In other examples, the processes of FIGS. 4 and 5 may be performed such that computing device 12 is configured to transmit provisioning information that is generic, or not unique, to each of user devices 14. For example, computing device 12 may be configured to transmit, via wireless device-to-device communication (e.g., Bluetooth communication), the provisioning information to user device 14N. The provisioning information may include one, two or more, or all of the following information: network credentials that allow user device 14N to access network 20, one or more setting values or configuration parameters that limit a respective function of user device 14N (e.g., device policy information), an administrator password that allows an administrator to access user device 14N, and/or instructions for user device 14N to automatically configure itself, via network 20, with at least one application for use by a user. In this manner, computing device 12 may be configured to transmit the same provisioning information to each user device 14. In response to receiving the generic provisioning information, each of user devices 14 may connect to network 20 and configure itself, via network 20, such that a user may use a respective one of user devices 14 and manually enter the appropriate user account information, such as a unique username and password.

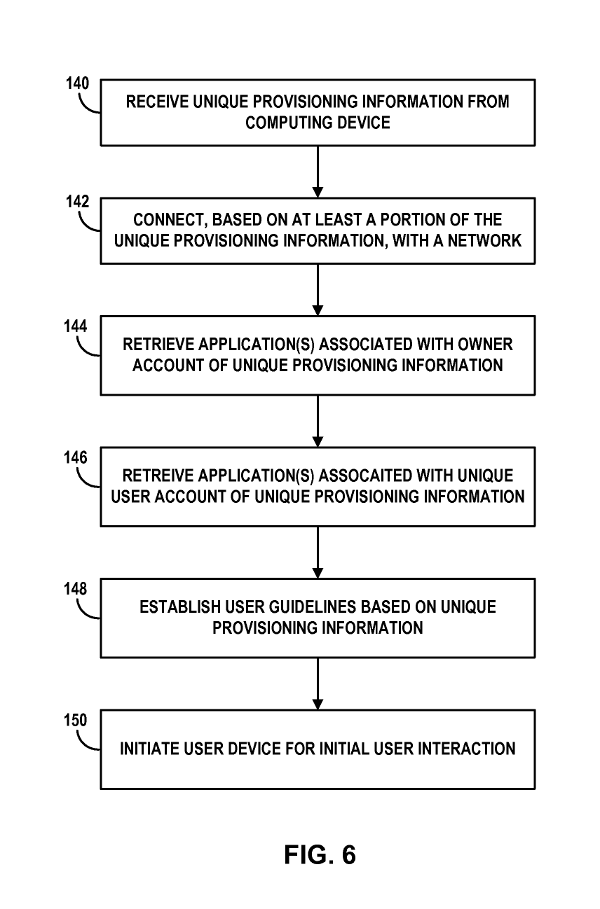

FIG. 6 is a flow diagram illustrating an example process for receiving, by a user device, unique provisioning information to self-provisioning the user device, in accordance with one or more aspects of this disclosure. The process of FIG. 6 may be representative of the self-provisioning process user devices undertake following the processes of FIG. 4 or 5. A user computing device, such as user device 14N described in FIGS. 1 and 3, may perform the process of FIG. 6. In some instances, one or more processors of a computing device, such as processors 70 (including self-provision module 90) of user device 14N of FIGS. 1 and 3, may perform the process of FIG. 6.

As shown in FIG. 6, processors 70 may receive a set of unique provisioning information from computing device 12 (140). In response to receiving the set of unique provisioning information, processors 70 may connect with a network (e.g., network 20) based on at least a portion of the unique provisioning information (142). For example, the unique provisioning information may include network credentials that authorize access to network 20.

Processors 70 may then communicate with one or more servers 22 to retrieve applications associated the owner account identified by the unique provisioning information (144). In addition, processors may 70 may communicate with one or more servers 22 to retrieve applications associated the user account identified by the unique provisioning information (146). Although one or more applications associated with an owner account may retrieved and/or installed, these applications may not be accessible by the user. In other examples, all of the applications and/or setting values retrieved from server 22 may be associated with the user account. Further, processors 70 may establish one or more user guidelines based on the received unique provisioning information (148). The user guidelines may be set by one or more of the owner account, the user account, and a device policy associated with one or both of the owner and user accounts.

After retrieving these applications and setting values, for example, processors 70 may initiate user device 14N for the initial user interaction with user device 14N (150). Completion of step 150 may signal the completion of the self-provisioning process. Once user device 14N is provisioned, processors 70 may set the user device to the home screen or lock screen. In some examples, the user may not need to perform any more provisioning steps to fully utilize user device 14N. In other examples, processors 70 may present one or more questions or steps to obtain new information from the user and/or any confirm that the provisioning process completed correctly.

Generally, user computing devices (e.g., user devices 14) are described as communicating directly to an administrator computing device (e.g., computing device 12) via wireless device-to-device communication. In this manner, each of user devices 14 may retrieve the respective provisioning information directly from computing device 12. In other examples, one of user devices 14 may be used as a proxy for computing device 12 transfer data between computing device 12 and other user devices 14. For example, user device 14A may communicate directly with computing device 12 (e.g., via Bluetooth connection) to receive provisioning information and perform the self-provisioning process. Either before or after the self-provisioning process is complete, user device 14A may establish a Wi-Fi access point (e.g., an ad hoc network) for connecting to additional user devices 14. User device 14A may establish this access point via Wi-Fi in order to accommodate more user devices 14 than may be possible over a Bluetooth connection of computing device 12. Computing device 12 be configured with only a single Wi-Fi radio. Therefore, computing device 12 may not be able to maintain a connection to network 20 via Wi-Fi and establish the Wi-Fi access point itself.

Computing device 12 may transmit instructions to user device 14A to broadcast a Wi-Fi access point with a network name of which other user devices 14 may recognize and subsequently connect. In this manner, computing device 12 and user device 14A may maintain a Bluetooth connection (e.g., short-range communication using the Bluetooth protocol) and user device 14A may establish a Wi-Fi connection to other user devices 14. These other user devices 14 may then communicate to computing device 12, through user device 14A, as otherwise described herein. For example, user devices 14 may transmit device identifiers to computing device 12 and receive respective provisioning information from computing device 12. The other user devices 14 may thus utilize multiple communication modalities to obtain the provisioning information. In some examples, computing device 12 may utilize two or more user devices 14 as Wi-Fi access points to facilitate the simultaneous provisioning of a greater number of user devices.

FIG. 7 is a conceptual diagram illustrating an example computing device 12 that is configured to facilitate the distribution of provisioning information from a configuration service to respective user devices 14. System 160 of FIG. 7 may be substantially similar to system 10 of FIG. 1. However, system 160 may allow for user devices 14 to receive provisioning information from a configuration service via a connection with an administrator device (e.g., computing device 12). As shown in FIG. 7, system 160 includes computing device 12, user devices 14A, 14B, and 14N (collectively “user devices 14”), network 20, networked server 22, and repository 24. Although computing device 12 and user device 14N are described, computing device 12 may refer to computing device 12B of FIG. 2B and user device 14N may refer to user device 14N.2 of FIG. 3B, for example.

In the example of FIG. 7, computing device 12 and user devices 14 are described as a tablet computing device (e.g., a mobile computing device). However, in other examples, computing device 12 and user devices 14 may be a personal digital assistant (PDA), a desktop computer, a laptop computer, a tablet computer, a portable gaming device, a portable media player, a camera, an e-book reader, a watch, or another type of computing device. Although computing device 12 and user devices 14 may all be the same type of device (e.g., tablet computing devices), different types of devices may still provide device-to-device communication used during the provisioning process. For example, computing device 12 may be a notebook computer and user devices 14 may be tablet computing devices. In addition, user devices 14 may, or may not, all be of the same type of computing device.

As shown in FIG. 7, computing device 12 (e.g., an administrator computing device) may establish a wireless device-to-device communication connection (e.g., communication according to a Bluetooth protocol) with user devices 14 and facilitate the transfer of provisioning information 164 from a configuration service (e.g., an Internet based service using server 22 and repository 24), through computing device 12, and to the respective user computing device 14. In other words, each of a plurality of user devices 14 may obtain provisioning information from the configuration service without using separate Internet connections (e.g., Wi-Fi Internet connections). Instead, user devices 14 may utilize the Internet connection of computing device 12 to obtain the respective provisioning information 164 (e.g., network credentials, a unique user account, and/or applications to install by the user device) from the configuration service. In this manner, computing device 12 may not store sensitive user account information, such as network credentials (e.g., network access passwords) or user account passwords. Instead, computing device 12 may act as a pass-through for communications between the new user devices 14 and the configuration service.

In one example, computing device 12 may comprise several different units, modules, or hardware that support different modes of data exchange. Computing device 12 (e.g., computing device 12B of FIG. 2B) may include an NFC unit, wireless device-to-device communication unit (e.g., a Bluetooth unit), and a network interface (e.g., a Wi-Fi unit) that establishes an Internet connection with a network such as network 20. Computing device 12 may also include one or more processors (e.g., processors 40) configured to control these different data exchange units to transmit and/or receive data and facilitate the transfer of provisioning information (e.g., provisioning information 164N) to non-provisioned user devices 14.

Computing device 12 may transmit, to user device 14N via NFC, network identifier 160 that identifies a wireless device-to-device communication connection (e.g., a Bluetooth connection) broadcast from computing device 12 and a service identifier that identifies a connection service of the wireless device-to-device communication connection. Computing device 12 may have already transmitted network identifier 160 and the service identifier to user devices 14A and 14B. In response to receiving network identifier 160 and the service identifier, user device 14N may then formulate and transmit request 162N back to computing device 12 via the wireless device-to-device communication connection and connection service. Request 162N may be a request to access a configuring server at a web address. The web address may be previously stored in a memory of user device 14N or also received from computing device 12. Request 162N may include information unique to user device 14N (e.g., an indication of the unique user account to be added to user device 14N or an indication of a unique device identifier of user device 14N).

In response to receiving request 162N, computing device 12 channels request 162N from the wireless device-to-device communication connection and through an Internet connection of network interface 41, for example, to network 20. Server 22 may then receive request 162N and generate and/or obtain provisioning information 164N based on data stored in repository 24. In this manner, server 22 and repository 24 may be at least part of the configuration service for user device 14N. The configuration service may be the same for all user devices 14. The web address may also identify server 22 on the worldwide web, or Internet, such that request 162N finds the configuration service. Server 22 may then transmit provisioning information 164N to network 20 and computing device 12.

Response to computing device 14 receiving provisioning information 164N from the configuration service of server 22 via the Internet connection, computing device 14 may channel provisioning information 164N to the wireless device-to-device communication connection and to user device 14N over the wireless device-to-device communication connection by using the connection service. In this manner, computing device 12 may act as a proxy for an Internet connection of user device 14N (i.e., user device 12N does not need network credentials or to establish its own Internet connection in order to receive provisioning information 164N). The connection service may support the proxy Internet connection and may be one of several services supported by the wireless device-to-device communication connection. Provisioning information 164N may include instructions for user device 14N to automatically configure itself with network credentials, one or more applications, or any other information specific to the unique user account. In this manner, provisioning information 164N may be unique to user device 14N and different from other provisioning information 164 sent to user devices 14A and 14B.

Although the example of FIG. 7 describes a single request 162N and a single packet of provisioning information 164N transferred between user device 14N and server 22, computing device 12 may be configured to support the transfer of multiple iterations of data transferred from user device 14N and/or multiple iterations of data transferred from server 22 to user device 14N. In this manner, transfer of request 162N and/or provisioning information 164N may include multiple iterations of two-way communication between user device 14N and server 22. Computing device 12 may support this communication via the wireless device-to-device communication connection and the connection service until user device 14N has obtained the complete provisioning information 164N needed for the self-provisioning process and/or user device 14N terminates the wireless device-to-device communication connection.

Computing device 12 may transmit network identifier 160, and the service identifier in some examples, when user device 14N is within NFC range of computing device 12. For example, computing device 12 may sense the NFC unit of user device 14N when user device 14N is within NFC range of computing device 12. Responsive to sensing user device 14N within NFC range, computing device 12 may control NFC unit 47 to transmit network identifier 160 and the service identifier to user device 14N. In some examples, computing device 12 may first validate user device 14N as a user device to which computing device 12 should transmit network identifier 160. For example, responsive to detecting user device 14N, computing device 12 may request a unique device identifier from user device 14N and validate the unique device identifier to a list of device identifiers to be provisioned. Responsive to the validation, computing device 12 may transmit network identifier 160 to user device 14N via NFC.

As described herein, the wireless device-to-device communication connection broadcast by computing device 12 may include a Bluetooth communication protocol. Network identifier 160 may include a media access control (MAC) address that identifies a wireless device-to-device communication unit (e.g., wireless device-to-device communication unit 49 of FIG. 2B) of computing device 12. Network identifier 160 may thus allow user devices 14 to find and connect to the wireless device-to-device communication connection broadcast by computing device 12. The service identifier may identify one of a plurality of services offered (e.g., Bluetooth services), or executing, with the wireless device-to-device communication connection. In other words, the service identifier may identify which connection service to use that will support the Internet connection proxy needed to access the configuration surface at the web address. In some examples, the service identifier may include a universally unique identifier (UUID) that identifies the connection service of the wireless device-to-device communication unit (e.g., unit 49). Although the service identifier may be transmitted with network identifier 160, the service identifier may be transmitted at a different time or computing device 12 may recognize the type of request (e.g., a request to reach the web address of the configuring device) and automatically assign the request to the appropriate connection service identifiable by the service identifier. The Internet connection established by computing device 12 to network 20 may include a protocol complying with an IEEE 802.11 standard for wireless communication (e.g., communication over Wi-Fi). Other types of communication may be used in other examples.

Computing device 12 may set up an Internet proxy to channel data (e.g., request 162N and provisioning information 164N) between the wireless device-to-device communication connection and the Internet connection. For example, this proxy may be an HTTP/HTTPS proxy so that request 162 is channeled through the Internet connection (e.g., established by a different unit such as a network interface) with network 20. The connection service of the less device-to-device communication connection may at least partially device this proxy. Incoming data such as provisioning information 164N targeted to user device 14N may be similarly channeled from the Internet connection through the wireless device-to-device communication connection and the connection service with user device 14N. In this manner, computing device 12 may not have access to the content of data exchanged between user device 14N and server 22. The Internet proxy then prevents computing device 12 from storing or using sensitive information that may be contained within provisioning information 164N (e.g., a network password unique to the unique user account of user device 14N). However, computing device 12 may still be able to obtain the web address or Internet location to which any data sent from user device 14N is intended to be sent. Computing device 12 may thus selectively transmit, based on the web address of a request, requests or other data from user device 14N over the Internet connection to network 20. If computing device 12 may thus block Internet traffic to or from unauthorized Internet locations. For example, computing device 12 may only allow Internet traffic to or from authorized configuration services needed by user devices 14N to complete the provisioning process.

The web address of the configuration service may be any address or location pointer that directs request 162N to the appropriate network, Internet, or cloud server 22. The web address may be a universal resource locator (URL) or any other such identifier. In some examples, user devices 14 may store the web address of the configuration service in a memory prior to receiving any information (e.g., network identifier 160 over NFC) from computing device 12. The web address may be hardcoded in software stored on user devices 14, stored in a memory, or otherwise obtained from another source. In this manner, each of user devices 14 may store a web address for which to use if the user device determines that it is not provisioned. Alternatively, computing device 12 may store the web address and transmit the web address to user device 14 over NFC, such as with network identifier 160 and the service identifier,

In some examples, computing device 12 may transmit additional information over NFC along with network identifier 160. For example, computing device 12 may transmit an indication of the unique user account to respective user devices 14. The unique user account may be selected from a plurality of unique user accounts stored by computing device 12. In other words, computing device 12 may store a list of unique user accounts that will be added to respective new user devices 14. Computing device 12 may select a unique user account that has not yet been added to one of user devices 14 and transmit that unique user account to the respective user device. In some examples, computing device 12 may receive a serial number or other unique device identifier from the respective user device 14 and select the unique user account associated with the unique device identifier in the list retained by computing device 12. This list of unique user accounts may be, for example, a list of students within a class where each student has a respective unique user account.

In other examples, computing device 12 may transmit a unique device identifier to user device 14N that identifies the user device. The unique device identifier may be selected from a plurality of unique identifiers stored by computing device 12. User device 14N may then ensure that computing device 12 is anticipating user device 14N and authorized to connect with user device 14N. For example, computing device 12 and user devices 14 may perform an authentication process as described in FIG. 5. In other examples, the unique device identifier transmitted by computing device 12 may be generated by obtained or generated by computing device 12, sent to user devices 14, and used as part of requests 162 to identify different user devices by the configuration service until the unique user account has been added to the respective user device 14.

Computing device 12 may connect, via the wireless device-to-device communication connection (e.g., Bluetooth) and the connection service, to multiple user devices 14 simultaneously. In this manner, computing device 12 may transmit network identifier 160 to subsequent user devices via NFC prior to one or more previous user devices 14 receiving the full provisioning information 164 for the respective user device. Computing device 12 may simultaneously communicate with several user devices 14 at any given time. The number of user device 14 to be simultaneously communicating with computing device 12 via the wireless device-to-device communication may be limited by a number of communication slots (channels) and/or available data bandwidth. Computing device 12 and/or user devices 14 may be configured to set up in a queue to transmit respective requests 162 to computing device 12. For example, each user devices 14 may continue to ping computing device 12 until computing device 12 has the bandwidth to respond.

User devices 14 may be configured to take one or more steps in response to determining that it has not yet been provisioned. In this manner, user devices 14 may, upon powering on, identify the lack of any installed user account or any provisioning that renders the user device unfit for use by an end user (e.g., the user of a unique user account). For example, user device 14N may be configured to, responsive to powering on, enable an NFC unit (e.g., near-field communication unit 77 of FIG. 3B) of user device 14N. Once the NFC unit is powered on, computing device 12 may be able to sense user device 14N and transmit network identifier 160.

Responsive to receiving the network identifier 160 and the service identifier, user device 14N may be configured to enable a wireless device-to-device communication unit (e.g., wireless device-to-device communication unit 79 having a Bluetooth protocol) to establish the wireless device-to-device communication connection between computing device 12 and user device 14N. In this manner, receipt of network identifier 160 for wireless device-to-device communication may prompt user device 14N to enable its own wireless device-to-device communication unit and establish the connection with the service connection, before transmitting request 162N. User devices 14 may also, in response to enabling the wireless device-to-device communication unit, establish an Internet proxy that channels all outgoing Internet communications through the wireless device-to-device communication connection instead of an Internet connection (e.g., a Wi-Fi connection via network interface 75) of the user device 14. The outgoing Internet data may include request 162N, for example, for accessing the configuration service of server 22. Establishing the Internet proxy may include setting up, by each user device 14, an HTTP/HTTPS proxy so that the respective request, and any other data intended for the configuration service, is channeled through the wireless device-to-device communication connection (e.g., Bluetooth connection) with computing device 12 instead of an Internet connection of the user device.

In some examples, user devices 14 may confirm that computing device 12 is authorized to communicate with the respective user device 14 prior to transmitting the respective request. For example, each of user devices 14 may receive one or more serial numbers (e.g., a unique device identifier) from computing device 12 and determine that the serial number matches a stored serial number of the respective user device. Responsive to determining that the serial number matches the serial number of the user device, the respective user device may transmit the request (e.g., request 162N) to computing device 12. In some examples, each user device 14 may receive the list of serial numbers for user devices and ensure that the respective serial number matches one entry of the list. In other examples, user devices 14 may transmit an encrypted serial number and wait to receive an authenticated serial number from computing device 12 (such as described in the example of FIG. 5.) If user devices 14 do not receive an authenticated answer, the user devices may refrain from transmitting the request and/or engaging in any other communication with computing device 12.

Each of user devices 14 may monitor the receipt of respective provisioning information 164 from computing device 12. In response to determining that receipt of provisioning information 164 has been completed, the user device may terminate the wireless device-to-device communication connection with computing device 12. In other examples, user devices 14 may terminate the wireless device-to-device communication with computing device 12 in response to determining that the configuring or self-provisioning process of the user device has been completed. Alternatively, each of user devices 14 may terminate the wireless device-to-device communication connection with computing device 12 responsive to verifying that an Internet connection (e.g., a Wi-Fi connection with network 20) has been established using network credentials from the respective provisioning information 164.

Although user devices 14 may receive network identifier 160 from computing device 12 via NFC, user devices 14 may alternatively obtain network identifier 160 from other sources. For example, user devices 14 may obtain network identifier 160, the service identifier, and/or the web address via NFC from another computing device or a passive NFC tag. In other examples, network identifier 160, the service identifier, and/or the web address may be stored as a Quick Response (QR) code, one-dimensional or two-dimensional bar code, or any other visual code obtained using a camera of the respective user device 14. In this manner, user devices 14 may obtain network identifier 160 of computing device 12 from sources other than computing device 12 in some examples.

As described herein, provisioning information 164 (e.g., provisioning information 164N) may include network credentials for user devices 14. The network credentials may identify a wireless network (e.g., network 20) detectable by user devices 14 and a password that allows the user devices to access the wireless network. In some examples, the password may be unique to each unique user account. In other examples, the password may be generic to one or more of user devices 14.

Using provisioning information received from server 22 via computing device 12, user devices 14 may perform a self-provisioning process as described herein. For example, user device 14N may configure itself with one or more applications of a unique user account, with one or more network credentials (e.g., a network identity and/or a network password for accessing the network identified by the network identity), set up one or more accounts, establish one or more security/privacy restrictions, disable one or more features, register the user device, or perform any other configuration tasks associated with the unique user account as indicated by provisioning information 164N. The self-provisioning process may be completed over the wireless device-to-device communication connection with computing device 12 and/or over an Internet connection established using the network credentials contained within provisioning information 164N.

In some examples, computing device 12 may receive account information for, or associated with, a plurality of users. The plurality of users may be end-users that will interact with respective user devices 14. For example, the plurality of users may be students enrolled in one or more classes, employees of a company, or any other group of users. Typically, the plurality of users may be associated with a single entity or institution. However, the plurality of users may be associated with different entities in other examples. The account information may include information associated with one or more types of accounts. For example, the account information may include information identifying and/or describing user accounts for each of the plurality of users. In some examples, each of the user accounts may be associated with groups of the users. Since each user account may differ by at least the user to which it is associated, the information related to the user accounts may make provisioning information for one of user devices 14 different than, or unique from, provisioning information for another one of user devices 14. In some examples, the user accounts may be stored in the form of a list of all users within a particular group of users that will receive user devices 14. Although the account information may include device identifiers for respective user devices 14 to be provisioned, the list of device identifiers may be stored separately and assigned to respective user accounts by computing device 12 and/or as part of the self-provisioning process completed by the respective user device 14.

The account information may also include information identifying and/or describing an owner account associated with an entity or institution that owns or otherwise manages user devices 14. The owner account may be common to all of user devices 14. In this manner, each of user devices 14 may be managed by the administrator that has access to the owner account. Management of each user device 14 may be performed remotely by an administrator via network 20 such that various tasks may be performed without user interaction. By including both owner account information and user account information, each of user devices 14 may be provisioned with the owner account and a unique user account.

In some examples, the owner account may be used during self-provisioning of user devices 14 (e.g., to set various setting values, validate user accounts, or provide temporary administrator access). After user device 14 is configured, or provisioned, user device 14 may delete the owner account from user device 14. In another example, the owner account may be a single-use account that is used during the provisioning process. This single-use account may be used by user device 14 to configure itself via network 20 and server 22. However, after user device 14 is configured with one or more user accounts, the single-use account may be inactive and/or deleted by user device 14.

In this manner, each unique provisioning information (e.g., provisioning information 164N) may include information indicative of one or more types data. The unique provisioning information may include information indicative of an owner account associated with an entity to be in control of user devices 14 and a respective user account associated with one of the plurality of users. The unique provisioning information may also include information related to a network and/or server that allows the respective user device 14 to connect to network 20 and retrieve applications, setting values, and any other information related to the owner account, the user account, or otherwise provision user device 14 for the user. In some examples, the information related to the network may include network credentials for accessing network 20. The network credentials may include the name of the network (e.g., a wireless network) and a password that enables the user device to access network 20. The password may be generic to all user accounts or user account specific (e.g., each set of unique provisioning information may include a different password to network 20). After receiving unique provisioning information that includes this data, the receiving user device may initiate the self-provisioning process (e.g., retrieving applications or any other data from server 22 to configure the user device for use by the user of the user account).

In some examples, the provisioning information may include or indicate a device policy that provides one or more limitations to respective functions of the user device. In other words, the device policy may be indicated by one or more setting values to respective features or functions that limit, block, or otherwise regulate each of user devices 14 to the requirements of the device policy. For example, the device policy may block certain component functions (e.g., cameras), functionalities, and/or access to various networks and/or websites, or restrict any other features or content. As another example, the setting values of the device policy may prevent a user from installing games or any other unauthorized applications. In other words, the device policy may set one or more rules for use or otherwise lockdown one or more functions of each one of user devices 14 before a user has access to the respective user device.

The device policy may be generic to all user accounts or customized to one or more user accounts. Each user device 14 may retrieve setting values for the device policy from server 22 during the self-provisioning process after receiving the unique provisioning information. Alternatively, the provisioning information transmitted by computing device 12 may include the one or more setting values for respective functions of the device policy. In other examples, the device policy may be included in or associated with the owner account and/or specific user account.

Provisioning information 164N may be unique provisioning information that is different from the provisioning information transmitted to any other user devices 14. Provisioning information 164N may thus include unique provisioning information specific for each of the plurality of users associated with respective user accounts. In this manner, server 22 may only transmit provisioning information 164N to user device 14N. Server 22 may be configured to transmit provisioning information 164 to any user device 14 that has not already received provisioning information or already been provisioned.

Although the provisioning information transmitted by computing device 12 may be unique for each of user devices 14 in some examples, the provisioning information may be generic for all user devices 14 in other examples. When computing device 12 is configured to transmit generic provisioning information, each user device 14 may receive user input identifying a specific user account to be added to the user device after the user device has self configured itself.

Provisioning information may include the actual data for each feature (e.g., the setting values) or an indication of the actual data such that user device 14 can reconstruct the actual data from the indication and/or retrieve the actual data via network 20. For example, the provisioning information may include an indication of an owner account and/or a device policy, and user device 14N may retrieve the administrator password and/or setting values related to the identified owner account or device policy from server 22. When user device 14N configures itself with at least one application for user by a user, user device 14N may initiate one or more software applications, set-up one or more functions for use, and/or download the applications or software related to the applications from server 22.

After user device 14N is configured with the generic provisioning information, a user (e.g., a student or employee) may interact with user device 14N to enter information related to the user account of the user. In response to receiving this information from the user, user device 14N may further configure itself with information related to the user account. User account information may be separately, or manually, entered by the user in situations in which the user account is already set-up to prevent computing device 12 from either acquiring the user's password and/or requiring the user to select a new password after the old user password was used to provision user device 14N via computing device 12.

Network 20 may be embodied as one or more of the Internet, a wireless network, a wired network, a cellular network, or a fiber optic network. In other words, network 20 may be any data communication protocol or protocols that facilitate data transfer between two or more devices. Networked server 22 may also connect to repository 24 for storing account information (e.g., owner accounts, user accounts, etc.) and/or applications or other information associated with such accounts and that may be used when each of user devices 14 are configuring themselves during the provisioning process.

Various aspects of the disclosure may be operable only when respective users have explicitly enabled such functionality. For example, in the instance where the user has consented to the use of any data, e.g., a user account for provisioning a respective user device, the data may be used to configure the respective user device for future use by the user. The user may consent or revoke consent to the collection and/or transmission of any data at any time.

In addition, various aspects of the disclosure may be disabled by the user. Thus, a user may elect to prevent an associated user device 14 from collection and/or transmitting information associated with the user device, obtained images, or any other information related to the actions of the user device. In addition, the user may prevent a user device from transmitting information identifiable of the user without confirmation. Moreover, an administrator for an entity of the owner account associated with each user device 14 may similarly consent to the use of any data and/or revoke consent to the use of such data for one or more of the users. User devices 14 may present one or more respective screens requesting that the user elect to transmit any or all information. In this manner, the user may control what information, if any, is transmitted to a network server or other computing device. More generally, privacy controls may be applied to all aspects of the disclosure based on a user's privacy preferences to honor the user's, or administrator's privacy preferences related to the use of computing device 12, any user device 14, or any other computing device or functionality described in this disclosure.

FIG. 8 is a flow diagram illustrating an example process for connecting user device 14N.2 with a configuration service via computing device 12B to distribute provisioning information 164N to the user device. For purposes of illustration only, the example process of FIG. 8 is described with respect to user device 14N.2 of FIG. 3B and computing device 12B of FIG. 2B and in the context of system 160 of FIG. 7. However, any other computing devices (e.g., computing devices 12 or 12A) or user devices (e.g., user devices 14A, 14B, or 14N) may be used to perform the features of FIG. 8.

As shown in FIG. 8, one or more processors 40 of computing device 12B may transmit, to user device 14N.2 and via NFC, network identifier 160 of computing device 12B and a service identifier that identifies a connection service of a wireless device-to-device communication connection (170). In some examples, processors 40 may transmit network identifier 160 and the service identifier to user device 14N.2 in response to sensing user device 14N.2 in NFC range of computing device 12B. Processors 40 may then receive, from user device 14N.2 and via wireless device-to-device communication (e.g., Bluetooth communication) connection identified by network identifier 160 and the connection service (e.g., a Bluetooth service) identified by the service identifier, a request to access the configuration service at a web address (172). The service identifier may instruct processors 40 to select one of a plurality of different Bluetooth services to use when receiving and/or handling the request, for example. The configuration service may be identified by the web address. In response to receiving the request, processors 40 may transmit the request to the web address of the configuration service via an Internet connection established by network interface 41 via network 20 (174).

After server 22 (e.g., the configuration service) obtains and transmits provisioning information 164N, processors 40 may receive, via the Internet connection, provisioning information 164N from the configuration service and for user device 14N.2 (176). The configuration service may mark provisioning information 164N with a device identifier of user device 14N.2 such that processors 40 can identify which user device 14 should receive provisioning information 164N. In response to receiving provisioning information 164N, processors 40 may transmit, via Bluetooth communication and the connection service, provisioning information 164N to user device 14N.2 (178).

Processors 40 may monitor the Bluetooth connections for the maintained connection with user device 14N.2 (180). If user device 14N.2 is still connected the Bluetooth communication connection of computing device 12B (“YES” branch of block 180), processors 40 may continue to receive provisioning information or other data from the configuration service (176). If user device 14N.2 is no longer connected to the Bluetooth communication connection (“NO” branch of block 180), processors 40 may terminate the Bluetooth communication connection for user device 14N.2. In some examples, processors 40 may recognize that user device 14N.2 is no longer connection by a status of connected devices provided by the connection service.

Although processors 40 are described as performing each step of FIG. 8, such as receiving or transmitting various information, processors 40 may be configured to control one or more communication units to transmit or receive such information. For example, processors 40 may control network interface 41 to transmit requests and receive provisioning information, control NFC units 47 to transmit network identifier 160, and/or control wireless device-to-device communication units 49 to receive requests from user device 14N.2 and transmit provisioning information 164N to user device 14N.2.

FIG. 9 is a flow diagram illustrating an example process for transmitting a request to and receiving provisioning information from a configuration service via a wireless device-to-device communication connection with computing device 12B. For purposes of illustration, the example process of FIG. 9 is described with respect to user device 14N.2 of FIG. 3B and computing device 12B of FIG. 2B and in the context of system 160 of FIG. 7. However, any other computing devices (e.g., computing devices 12 or 12A) or user devices (e.g., user devices 14A, 14B, or 14N) may be used to perform the features of FIG. 8.

As shown in FIG. 9, one or more processors 70 of user device 14N.2 may be configured to receive, from computing device 12B and via NFC, network identifier 160 of computing device 12B and a service identifier that identifies a connection service of the wireless device-to-device communication connection (190). In some examples, processors 70 may enable the NFC unit of user device 14N.2 in response to determining that user device 14N.2 has not yet been provisioned for a user account. In response to receiving network identifier 160 and the service identifier, processors 70 may enable a wireless device-to-device communication unit (e.g., wireless device-to-device communication unit 79 such as a Bluetooth unit) and establish an Internet proxy to channel outgoing Internet communications through the Bluetooth unit (192). Processors 70 may also connect to computing device 12B via the Bluetooth connection and the connection service once the Bluetooth unit is enabled. The Internet proxy may allow outgoing data, such as request 162N, to be sent to computing device 12B. In response to establishing the Bluetooth communication connection, processors 70 may transmit, to computing device 12B and via Bluetooth communication, request 162N to access a configuration service via a web address (194). In some examples, the web address may be previously stored in a memory of user device 14N.2, such as self-provision module 90. The web address may be hardcoded or otherwise stored. In other examples, user device 14N.2 may receive the web address from computing device 12B, another computing device, a passive NFC tag, an optical code, or any other source. Computing device 12B may then channel request 162N to server 22 via an Internet connection (e.g., a Wi-Fi connection) and network 20 for receiving provisioning information 164N from server 22.

Processors 70 may then receive, via Bluetooth communication and the connection service, provisioning information 164N from computing device 12B and via the Internet connection of computing device 12B (196). Responsive to receiving provisioning information 164N, processors 70 may establish an Internet connection (e.g., a Wi-Fi connection) via network interface 75 with the received provisioning information 164N (198). For example, provisioning information 164N may include network credentials such as the network name and password that allows processors 70 to connect with network 20. If processors 70 cannot verify an Internet connection via network interface 75 (“NO” branch of block 200), processors 70 may continue to establish the Internet connection (198). If processors 70 verify the Internet connection (“YES” branch of block 200), processors 70 may remove the Internet proxy and terminate the Bluetooth communication connection with computing device 12B (202).

The provisioning information may include instructions for user device 14N.2 to automatically configure itself with one or more applications of a unique user account, with one or more network credentials (e.g., a network identity and/or a network password for accessing the network identified by the network identity), set up one or more accounts, establish one or more security/privacy restrictions, disable one or more features, register the user device, or perform any other configuration tasks specific to the unique user account of user device 14N.2. In some examples, processors 70 may proceed to perform this self-provisioning process over the Internet connection established between network interface 75 and network 20 until user device 14N.2 is successfully provisioned. In other examples, processors 70 may maintain the Bluetooth connection with computing device 12B to partially or fully complete the self-provisioning process via the Bluetooth connection and connection service with computing device 12B. In other words, provisioning information 164N may include as little information as network credentials for one or more networks 20 over which user device 14N.2 can proceed to perform the self-provisioning process. Alternatively, provisioning information 164N may include as much information as needed for processors 70 to complete the self-provisioning process.

Although processors 70 are described as performing each step of FIG. 9, such as receiving or transmitting various information, processors 70 may be configured to control one or more communication units to transmit or receive such information. For example, processors 70 may control network interface 75 to establish an Internet connection, control NFC units 77 to receive network identifier 160 and the service identifier, and/or control wireless device-to-device communication units 79 to transmit request 162N from user device 14N.2 and receive provisioning information 164N from computing device 12B.

Various examples are described herein. Example 1 may include a method that includes receiving, by a first computing device, account information for a plurality of users and a plurality of device identifiers, receiving, by the first computing device and from a second computing device via wireless device-to-device communication, a unique device identifier that identifies the second computing device, determining that the unique device identifier matches one of the plurality of device identifiers received by the first computing device, and responsive to the determination, transmitting, by the first computing device and via the wireless device-to-device communication, provisioning information to the second computing device, wherein the provisioning information comprises instructions for the second computing device to automatically configure itself, via a network, with one or more applications of a user account associated with one or more of the plurality of users.

Example 2 may include the method of example 1, wherein the wireless device-to-device communication comprises a communication that uses a short-range communication protocol.

Example 3 may include the method of any of examples 1 and 2, further comprising broadcasting, by the first computing device, a provisioning service via the wireless device-to-device communication, wherein receiving the unique device identifier comprises receiving the unique device identifier from the second computing device via the provisioning service.

Example 4 may include the method of example 3, wherein broadcasting the provisioning service comprises sensing, by the first computing device, the second computing device in a wireless communication range of the first computing device and transmitting, by the first computing device, a request for the representation of the unique device identifier from the second computing device.

Example 5 may include the method of any of examples 1 through 4, wherein the unique device identifier comprises a serial number of the second computing device.

Example 6 may include the method of any of examples 1 through 5, wherein receiving the unique device identifier comprises receiving a first encrypted representation of the unique device identifier, and wherein the method further comprises decrypting, by the first computing device, the first encrypted representation to obtain the unique device identifier, and transmitting, by the first computing device, a second encrypted representation of the unique device identifier to the second computing device, wherein the first encrypted representation is different than the second encrypted representation, and wherein the second computing device is configured to authenticate the provisioning information by decrypting the second encrypted representation and matching the decrypted second encrypted representation to the unique device identifier.

Example 7 may include the method of any of examples 1 through 6, wherein the provisioning information comprises unique provisioning information specific for each of the plurality of users, and wherein the method further comprises generating, by the first computing device, the unique provisioning information for each of the plurality of users.

Example 8 may include the method of any of examples 1 through 7, wherein the provisioning information comprises information indicative of an owner account associated with an entity in control of the second computing device, the user account associated with one of the plurality of users, one or more setting values that limit a respective function of the second computing device, and network credentials for accessing the network.

Example 9 may include the method of any of examples 1 through 8, wherein the provisioning information is first provisioning information different from second provisioning information, and wherein the method further comprises transmitting, simultaneously with the first provisioning information and via the wireless device-to-device communication, the second provisioning information to a third computing device.

Example 10 may include the method of any of examples 1 through 9, wherein the first computing device and the second computing device are each mobile computing devices.

Example 11 may include a computing device comprising one or more processors configured to receive account information for a plurality of users and a plurality of device identifiers, receive, from a user computing device via wireless device-to-device communication, a unique device identifier that identifies the user computing device, determine that the unique device identifier matches one of the plurality of device identifiers received by the computing device, and responsive to the determination, transmit, via the wireless device-to-device communication, provisioning information to the user computing device, wherein the provisioning information comprises instructions for the user computing device to automatically configure itself, via a network, with one or more applications of a user account associated with one or more of the plurality of users.

Example 12 may include the computing device of example 11, wherein the wireless device-to-device communication comprises a Bluetooth short-range communication protocol.

Example 13 may include the computing device of any of examples 11 and 12, further comprising a short-range communication unit configured to broadcast a provisioning service via the wireless device-to-device communication, wherein the one or more processors are configured to receive the unique device identifier from the user computing device via the provisioning service.

Example 14 may include the computing device of example 13, wherein the one or more processors are configured to, via the short-range communication unit sense the user computing device in wireless communication range of the computing device, and transmit a request for the representation of the unique device identifier from the user computing device.

Example 15 may include the computing device of any of examples 11 through 14, wherein the unique device identifier comprises a serial number of the user computing device.

Example 16 may include the computing device of any of examples 11 through 15, wherein the one or more processors are configured to receive a first encrypted representation of the unique device identifier, decrypt the first encrypted representation to obtain the unique device identifier, and transmit a second encrypted representation of the unique device identifier to the user computing device, wherein the first encrypted representation is different than the second encrypted representation, and wherein the user computing device is configured to authenticate the provisioning information by decrypting the second encrypted representation and matching the decrypted second encrypted representation to the unique device identifier.

Example 17 may include the computing device of any of examples 11 through 16, wherein the provisioning information comprises unique provisioning information specific for each of the plurality of users, and wherein the one or more processors are configured to generate the unique provisioning information for each of the plurality of users.

Example 18 may include the computing device of any of examples 11 through 17, wherein the provisioning information comprises information indicative of an owner account associated with an entity in control of the user computing device, the user account associated with one of the plurality of users, one or more setting values that limit a respective function of the user computing device, and network credentials for accessing the network.

Example 19 may include the computing device of any of examples 11 through 18, wherein the provisioning information is first provisioning information different from second provisioning information and the user computing device is a first user computing device, and wherein the one or more processors are configured to transmit, simultaneously with the first provisioning information and via the wireless device-to-device communication, the second provisioning information to a second user computing device.

Example 20 may include the computing device of any of examples 11 through 19, wherein the computing device and the user computing device are both mobile computing devices.

Example 21 may include a computer-readable storage medium comprising instructions that, when executed, configure one or more processors of a computing device to receive account information for a plurality of users and a plurality of device identifiers, receive, from a user computing device via wireless device-to-device communication, a unique device identifier that identifies the user computing device, determine that the unique device identifier matches one of the plurality of device identifiers received by the computing device, and responsive to the determination, transmit, via the wireless device-to-device communication, provisioning information to the user computing device, wherein the provisioning information comprises instructions for the user computing device to automatically configure itself, via a network, with one or more applications of a user account associated with one or more of the plurality of users.

Example 22 includes a method comprising receiving, by a first computing device and from a second computing device via wireless device-to-device communication, a unique device identifier that identifies the second computing device, determining that the unique device identifier matches one of a plurality of device identifiers received by the first computing device, and responsive to the determination, transmitting, by the first computing device and via wireless device-to-device communication, provisioning information to the second computing device, wherein the provisioning information comprises: network credentials that allow the second computing device to access a network, one or more setting values that limit a respective function of the second computing device, an administrator password, and instructions for the second computing device to automatically configure, via the network, itself with at least one application for use by a user.

Example 23 includes a method comprising determining, by a first computing device, that no user account has been established on the first computing device, responsive to the determination, initiating, by the first computing device, a short-range communication unit that is configured to communicate via wireless device-to-device communication, responsive to detecting a second computing device that broadcasts a provisioning service via the wireless device-to-device communication, transmitting, by the first computing device and to the second computing device, a unique device identifier that identifies the first computing device, receiving, by the first computing device and from the second computing device, provisioning information comprising instructions for the first computing device to automatically configure itself, via a network, with one or more applications of a user account, and responsive to receiving the provisioning information, automatically configuring, by the first computing device and via a network, the first computing device with the one or more applications of the user account.

In one or more examples, the functions described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media or computer-readable storage devices. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
transmitting, by a first computing device and to a second computing device via near-field communication, a network identifier and a service identifier, wherein the network identifier identifies a wireless device-to-device communication connection broadcast from the first computing device, and wherein the service identifier identifies a connection service of the wireless device-to-device communication connection;
receiving, by the first computing device and from the second computing device via the wireless device-to-device communication connection and the connection service, a request to access a configuration service at a web address;
responsive to receiving the request, transmitting, by the first computing device, the request to the web address of the configuration service via an Internet connection of the first computing device;
receiving, by the first computing device and via the Internet connection, provisioning information from the configuration service and for the second computing device; and
transmitting, by the first computing device and via the wireless device-to-device communication connection and the connection service, the provisioning information to the second computing device, wherein the provisioning information comprises instructions for the second computing device to automatically configure itself with a wireless network detectable by the second computing device and a password that allows the second computing device to access the wireless network for a unique user account associated with the second computing device.

2. The method of claim 1, further comprising sensing, by the first computing device, the second computing device in a near-field communication range of the first computing device, and wherein transmitting the network identifier and the web address comprises, responsive to sensing the second computing device in the near-field communication range of the first computing device, transmitting the network identifier and the service identifier to the second computing device.

3. The method of claim 1, wherein:
the wireless device-to-device communication connection comprises a Bluetooth communication protocol,
the network identifier comprises a media access control address that identifies a wireless device-to-device communication unit of the first computing device,
the service identifier comprises a universally unique identifier that identifies the connection service of the wireless device-to-device communication unit, and
the Internet connection comprises a protocol complying with an IEEE 802.11 standard for wireless communication.

4. The method of claim 1, further comprising transmitting, by the first computing device and via near-field communication, an indication of the unique user account to the second computing device, wherein the unique user account is selected from a plurality of unique user accounts stored by the first computing device.

5. The method of claim 1, wherein the web address of the configuration service is stored in a memory of the second computing device prior to transmission of the network identifier and the service identifier to the second computing device.

6. The method of claim 1, wherein the provisioning information comprises instructions for the second computing device to automatically configure itself with one or more applications of the unique user account.

7. The method of claim 1, wherein the request is a first request, the provisioning information is first provisioning information unique to the second computing device, and the unique user account is a first unique user account, and wherein the method further comprises:
transmitting, by the first computing device and to a third computing device via near-field communication, a network identifier that identifies the wireless device-to-device communication connection and the service identifier that identifies the connection service of the wireless device-to-device communication connection;
receiving, by the first computing device and from the third computing device via the wireless device-to-device communication connection and the connection service, a second request to access the configuration service at the web address;
responsive to receiving the second request, transmitting, by the first computing device, the request to the web address of the configuration service via the Internet connection of the first computing device;
receiving, by the first computing device and via the Internet connection, second provisioning information from the configuration service and for the third computing device; and
transmitting, by the first computing device and via the wireless device-to-device communication connection and the connection service, the second provisioning information to the third computing device, wherein the second provisioning information comprises instructions for the third computing device to automatically configure itself with a wireless network detectable by the third computing device and a password that allows the third computing device to access the wireless network for a second unique user account associated with the third computing device, wherein the first computing device is connected to both the second computing device and the third computing device simultaneously via the wireless device-to-device communication connection.

8. The method of claim 1, wherein the first computing device and the second computing device are both mobile computing devices.

9. An administrator computing device, the device comprising:
a near-field communication unit configured to exchange data via near-field communication;
a wireless device-to-device communication unit configured to exchange data via a wireless device-to-device communication connection;
a network interface configured to establish an Internet connection; and
one or more processors configured to:
control the near-field communication unit to transmit, to a first computing device via near-field communication, a network identifier and a service identifier, wherein the network identifier identifies the wireless device-to-device communication connection broadcast from the wireless device-to-device communication unit, and wherein the service identifier identifies a connection service of the wireless device-to-device communication connection;
control the wireless device-to-device communication unit to receive, from the first computing device via the wireless device-to-device communication connection and the connection service, a request to access a configuration service at a web address;
responsive to receiving the request, control the network interface to transmit the request to the web address of the configuration service via the Internet connection;
receive, via the Internet connection, provisioning information from the configuration service and for the first computing device; and
control the wireless device-to-device communication unit to transmit, via the wireless device-to-device communication connection and the connection service, the provisioning information to the first computing device, wherein the provisioning information comprises instructions for the first computing device to automatically configure itself with a wireless network detectable by the first computing device and a password that allows the first computing device to access the wireless network for a unique user account associated with the first computing device.

10. The device of claim 9, wherein:
the near-field communication unit is configured to sense the first computing device in a near-field communication range of the administrator computing device; and
the one or more processors are configured to, responsive to sensing the first computing device in the near-field communication range of the administrator computing device, control the near-field communication unit to transmit the network identifier and the service identifier to the first computing device.

11. The device of claim 9, wherein:
the wireless device-to-device communication connection comprises a Bluetooth communication protocol,
the network identifier comprises a media access control address that identifies a wireless device-to-device communication unit of the administrator computing device,
the service identifier comprises a universally unique identifier that identifies the connection service of the wireless device-to-device communication unit, and
the Internet connection comprises a protocol complying with an IEEE 802.11 standard for wireless communication.

12. The device of claim 9, wherein the one or more processors are configured to control the near-field communication unit to transmit, via near-field communication, an indication of the unique user account to the first computing device, wherein the unique user account is selected from a plurality of unique user accounts stored by the administrator computing device.

13. The device of claim 9, wherein the web address of the configuration service is stored in a memory of the first computing device prior to transmission of the network identifier and the service identifier to the first computing device.

14. The device of claim 9, wherein the provisioning information comprises instructions for the first computing device to automatically configure itself with one or more applications of the unique user account.

15. The device of claim 9, wherein the request is a first request, the provisioning information is first provisioning information unique to the first computing device, and the unique user account is a first unique user account, and wherein the one or more processors are configured to:
control the near-field communication unit to transmit, to a second computing device via near-field communication, a network identifier that identifies the wireless device-to-device communication connection and the service identifier that identifies the connection service of the wireless device-to-device communication connection;
control the wireless device-to-device communication unit to receive, from the second computing device via the wireless device-to-device communication connection and the connection service, a second request to access the configuration service at the web address;
responsive to receiving the second request, control the network interface to transmit the request to the web address of the configuration service via the Internet connection of the administrator computing device;
receive, via the Internet connection, second provisioning information from the configuration service and for the second computing device; and
control the wireless device-to-device communication unit to transmit, via the wireless device-to-device communication connection and the connection service, the second provisioning information to the second computing device, wherein the second provisioning information comprises instructions for the second computing device to automatically configure itself with a wireless network detectable by the second computing device and a password that allows the second computing device to access the wireless network for a second unique user account associated with the second computing device, wherein the administrator computing device is connected to both the first computing device and the second computing device simultaneously via the wireless device-to-device communication connection.

16. The device of claim 9, wherein the administrator computing device and the first computing device are both mobile computing devices.

17. A computer-readable storage medium comprising instructions that, when executed, configure one or more processors of a first computing device to:
transmit, to a second computing device via near-field communication, a network identifier and a service identifier, wherein the network identifier identifies a wireless device-to-device communication connection broadcast from the first computing device, and wherein the service identifier identifies a connection service of the wireless device-to-device communication connection;
receive, from the second computing device via the wireless device-to-device communication connection and the connection service, a request to access a configuration service at a web address;
responsive to receiving the request, transmit the request to the web address of the configuration service via an Internet connection of the first computing device;
receive, via the Internet connection, provisioning information from the configuration service and for the second computing device; and
transmit, via the wireless device-to-device communication connection and the connection service, the provisioning information to the second computing device, wherein the provisioning information comprises instructions for the second computing device to automatically configure itself with a wireless network detectable by the second computing device and a password that allows the second computing device to access the wireless network for a unique user account associated with the second computing device.

18. The computer-readable storage medium of claim 17, further comprising instructions that configure the one or more processors to sense the second computing device in a near-field communication range of the first computing device, and wherein the instructions that configure the one or more processors to transmit the network identifier and the web address comprise instructions that configure the one or more processors to, responsive to sensing the second computing device in the near-field communication range of the first computing device, transmit the network identifier and the service identifier to the second computing device.

19. The computer-readable storage medium of claim 17, wherein:
the wireless device-to-device communication connection comprises a Bluetooth communication protocol,
the network identifier comprises a media access control address that identifies a wireless device-to-device communication unit of the first computing device,
the service identifier comprises a universally unique identifier that identifies the connection service of the wireless device-to-device communication unit, and
the Internet connection comprises a protocol complying with an IEEE 802.11 standard for wireless communication.

20. The computer-readable storage medium of claim 17, further comprising instructions that configure the one or more processors to transmit, via near-field communication, an indication of the unique user account to the second computing device, wherein the unique user account is selected from a plurality of unique user accounts stored by the first computing device.
